(19) United States
(12) Patent Application Publication
(10) Pub. No.: US 2011/0250413 A1
(43) Pub. Date: Oct. 13, 2011

(54) BOND PATTERNS FOR FIBROUS WEBS

(76) Inventors: Jon Aaron LU, Cincinnati, OH (US); Olaf Erik Alexander Isele, West Chester, OH (US); Robert Haines Turner, Cincinnati, OH (US); Michael Timothy Looney, Blue Ash, OH (US); Khalid Qureshi, Mason, OH (US)

(21) Appl. No.: 13/035,274

(22) Filed: Feb. 25, 2011

Related U.S. Application Data
(60) Provisional application No. 61/308,182, filed on Feb. 25, 2010.

(51) Int. Cl. B32B 7/14; B32B 5/02

(52) U.S. Cl. 428/196

(57) ABSTRACT

Bond patterns for fibrous webs.

### CROSS-REFERENCE TO RELATED APPLICATION

This application claims priority to U.S. provisional application 61/308,182, filed Feb. 25, 2010, which is hereby incorporated by reference.

### FIELD

In general, embodiments of the present disclosure relate to fibrous webs. In particular, embodiments of the present disclosure relate to bond patterns for fibrous webs.

### BACKGROUND

Absorbent articles include diapers and incontinence garments as well as feminine pads and liners. Many absorbent articles are made with fibrous webs such as nonwovens. A fibrous web can include a bond pattern. The bond pattern can help increase the strength of the fibrous web, but may reduce the softness of the fibrous web. The strength and softness of the bonded fibrous web often depend on the particular geometry of the bond pattern. Unfortunately, it can be difficult to determine a bond pattern that provides adequate strength and softness.

### SUMMARY

However, embodiments of the present disclosure can be used to make bonded fibrous webs that are sufficiently strong and adequately soft. As a result, absorbent articles that are made with these bonded fibrous webs will also be strong and soft. Embodiments of the present disclosure can be used to make bonded fibrous webs that are aesthetically pleasing. In particular, the bond patterns can act as visual cues, communicating the softness of the bonded fibrous webs.

### BRIEF DESCRIPTION OF THE DRAWINGS

FIG. 1 is a top view of a fibrous web having a first bond pattern.

FIG. 2 is a top view of a fibrous web having a second bond pattern.

FIG. 3 is a top view of a fibrous web having a third bond pattern.

FIG. 4 is a top view of a fibrous web having a fourth bond pattern.

FIG. 5 is a top view of a fibrous web having a fifth bond pattern.

FIG. 6A is an inside plan view of a front-fastenable wearable absorbent article, which can include a fibrous web having a bond pattern of the present disclosure.

FIG. 6B is an inside plan view of a pant-type wearable absorbent article, which can include a fibrous web having a bond pattern of the present disclosure.

FIG. 6C is an inside plan view of a feminine pad absorbent article, which can include a fibrous web having a bond pattern of the present disclosure.

FIG. 7 is a top view of a fibrous web having a seventh bond pattern.

FIG. 8 is a top view of a fibrous web having an eighth bond pattern.

FIG. 9 is a top view of a fibrous web having a ninth bond pattern.

FIG. 10 is a top view of a fibrous web having a tenth bond pattern.

FIG. 11 is a top view of a fibrous web having an eleventh bond pattern.

FIG. 12 is a top view of a fibrous web having a twelfth bond pattern.

FIG. 13 is a top view of a fibrous web having a thirteenth bond pattern.

FIG. 14 is a top view of a fibrous web having a fourteenth bond pattern.

FIG. 15 is a top view of a fibrous web having a fifteenth bond pattern.

FIG. 16 is a top view of a fibrous web having a sixteenth bond pattern.

FIG. 17 is a top view of a fibrous web having a seventeenth bond pattern.

FIG. 18 is a top view of a fibrous web having an eighteenth bond pattern.

FIG. 19 is a top view of a fibrous web having a nineteenth bond pattern.

FIG. 20 is a top view of a fibrous web having a twentieth bond pattern.

FIG. 21 is a top view of a fibrous web having a twenty-first bond pattern.

FIG. 22 is a top view of an exemplary bond with an overall shape that is rectangular.

FIG. 23 is a top view of an exemplary bond with an overall shape that is rectangular with squared off corners.

FIG. 24 is a top view of an exemplary bond with an overall shape that is rectangular with rounded corners.

FIG. 25 is a top view of an exemplary bond with an overall shape that is substantially rectangular with semicircular ends.

FIG. 26 is a top view of an exemplary bond with an overall shape that is oval.

FIG. 27 is a top view of an exemplary bond with an overall shape that is hexagonal.

FIG. 28 is a top view of an exemplary bond with an overall shape that is diamond shaped.

FIG. 29 is a top view of a bonded fibrous web, which is the reference material.

FIG. 30 is a top view of a tensioning apparatus, for use in a test method.

FIG. 31 is a top view of a test sample of a bonded fibrous web, for use in a test method.

FIG. 32A is a side view of a step in a method of securing a tensioning apparatus to a test sample.

FIG. 32B is a side view of another step in a method of securing a tensioning apparatus to a test sample.

FIG. 32C is a side view of a further step in a method of securing a tensioning apparatus to a test sample.

FIG. 32D is a side view of a still further step in a method of securing a tensioning apparatus to a test sample.

FIG. 33 is a top view of a tensioning apparatus secured to a test sample.

FIG. 34 is a side view of a tensioning apparatus secured to a test sample.

FIG. 35 is a bottom view of a tensioning apparatus secured to a test sample.

FIG. 36 is a top view of a prepared test sample prior to tensioning in a method of determining neckdown modulus.

FIG. 37 is a top view of a prepared test sample during tensioning in a method of determining neckdown modulus.

### DETAILED DESCRIPTION

The term fibrous web refers to a sheet-like structure of fibers or filaments that are interlaid in a non-uniform, irregular, or random manner. An example of a fibrous web is a nonwoven web. A fibrous web can be a single layer structure or a multiple layer structure. A fibrous web can also be joined to another material, such as a film, to form a laminate. A fibrous web can be made from various natural and/or synthetic materials. Exemplary natural materials include cellulosic fibers, cotton, jute, pulp, wool, and the like. Natural fibers for a fibrous web can be prepared using various processes such as carding, etc. Exemplary synthetic materials include but are not limited to synthetic thermoplastic polymers that are known to form fibers, which include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate and the like; polycarbonate; polystyrene; thermoplastic elastomers; vinyl polymers; polyurethane; and blends and copolymers thereof. Synthetic fibers for a fibrous web can be produced using various processes such as meltblowing, spunbonding, etc.

The term “bonded fibrous web” refers to a fibrous web bonded with a bond pattern. The term “bond pattern” refers to a pattern of bonds imparted to a fibrous web. The term “bond” refers to a distinct location, on a bonded fibrous web, at which the fibers or filaments are substantially more interconnected, when compared with the fibers or filaments of the area of the fibrous web at least partially surrounding the bond (i.e. the unbonded area). The term “bond perimeter” refers to the outermost edge of the bond that defines the boundary between the bond area and the surrounding unbonded area. The term “bond area” refers to the percent of the total area of the bonded web that is occupied by the sum of the areas of the bonds that form the bond pattern.

A bond pattern can be imparted to a fibrous web in various ways, such as by using heat, pressure, ultrasonic bonding, adhesive, other bonding means known in the art, or combinations of any of these. For example, a fibrous web can be bonded by passing the fibrous web through a nip formed by a heated calendar roll (with a plurality of raised lands) and another roll, such that the lands form bond areas on the fibrous web.

Throughout the present disclosure, each of the fibrous bonded webs is illustrated as laid out flat. As a result, each of the webs, and each of the bond patterns on the webs, and each of the bond areas in the bond patterns are lying flat, in substantially the same plane. Accordingly, each of the angles, dimensions, directions, measurements, and frames of reference described herein is in the plane of the web.

Prior to undergoing web bonding by such techniques as described above, an un-bonded fibrous web possesses weak mechanical properties (e.g. tensile strength in CD, tensile strength in MD, web modulus, neckdown modulus, etc.) as compared with a bonded fibrous web since its constituent fibers/filaments are largely unconnected. An un-bonded fibrous web thus behaves more as a random matrix of largely unconnected individual fibers, with more freedom to move independently of each other than the more interconnected fibers of a bonded fibrous web. The largely unconnected fibers of an un-bonded fibrous web are less constrained and free to extend when placed under strain, resulting in a web that is weak in tensile strength, high in peak extension, and possesses a high Poisson ratio (i.e. low neckdown modulus). Such an un-bonded fibrous web is more difficult to handle in web converting operations (such as metering, transfer, roll winding/unwinding, slitting, etc.) not only due to its tendency to neckdown, waver, break, and/or extend, but also the propensity for individual fibers to disconnect from the un-bonded fibrous web resulting in dust, lint, and/or fiber contamination buildup.

For this reason it is desirable to consolidate the free fibers of an un-bonded fibrous web by web bonding through such techniques as described above in order to form a bonded fibrous web. A bonded fibrous web behaves more as a network of fibers that are interconnected to form a more uniform and structured web, with less freedom for individual fibers to move independently of each other than the more unconnected fibers of an un-bonded fibrous web. The largely interconnected fibers of a bonded fibrous web are more constrained and less free to extend when placed under strain, resulting in a web that is higher in tensile strength, lower in peak extension, and possesses a lower Poisson ratio (i.e. higher neckdown modulus). Such a bonded fibrous web is less difficult to handle in web converting operations (such as metering, transfer, roll winding/unwinding, slitting, etc.) not only due to its tendency to resist neckdown, wavering, breakage, and/or extension, but also the propensity of individual fibers to stay connected to the bonded web resulting in lower dust, lint, and/or fiber contamination buildup.

As a result of constraining the free movement of an un-bonded fibrous web's individual fibers, bonding also decreases the web's flexibility, pliability, extensibility, softness, fluid handling, and z-direction thickness (i.e. caliper), etc. properties that may be desirable in many end-use applications. Through careful selection of fiber chemistry (e.g. resin formulation, inclusion of additives, bicomponent configuration, etc.), management of fiber laydown parameters (e.g. fiber diameter, attenuation, fiber curl, extrusion pressure, etc.), and/or manipulation of bonding energy (thermal, chemical, pressure, shear, etc.) it is possible for one skilled in the art to mitigate the loss in flexibility, pliability, extensibility, softness, fluid-handling, and/or caliper, etc. caused by the bonding process to a degree, while maintaining properties such as tensile strength, neckdown modulus, web modulus, toughness, and/or tear resistance, etc. However, each of the techniques mentioned above bring additional trade-offs (e.g. added cost, decreased throughput, lower process robustness, increased propensity for fuzz and/or linting contamination, etc.) and are limited in effectiveness.

A different method (that may be exercised independently of or in addition to one or more of the above techniques) to improve flexibility, pliability, extensibility, softness, fluid-handling, and/or caliper etc. without compromise to tensile strength, neckdown modulus, web modulus, toughness, and/or tear resistance etc. is through bond pattern geometry. This technique brings the advantage over the others listed above in that bond pattern geometry can be manipulated to deliver desired web properties with less significant trade-offs in cost, complexity, throughput, process robustness, etc.

Increasing the overall bond area of a bonded fibrous web's bond pattern will, in general, improve properties such as tensile strength, neckdown modulus, web modulus, toughness, and/or tear resistance etc. at a sacrifice to properties such as flexibility, pliability, extensibility, softness, fluid-handling, and/or caliper etc. It is thus desirable to design a bond pattern that possesses a relatively low bond area (<26%, <23%, <20%, <17%, <14%, <11%) and is thus capable of delivering properties such as tensile strength, neckdown modulus, web modulus, toughness and/or tear resistance etc. without compromise to properties such as flexibility, pliability, extensibility, softness, fluid-handling, and/or caliper etc. to the bonded fibrous web. Such patterns can be designed by manipulation not of the overall bond area, but of the bond pattern's shape and spatial geometry, as described in embodiments of the present disclosure.

The term “Bl” refers to an overall length of a bond, measured linearly from one end of the bond to the other end of the bond, forming the bond's longest dimension. The term “Bw” refers to an overall width of a bond, measured linearly, perpendicular to Bl, across the bond's widest width. The term “shape ratio” refers to the ratio of Bw to Bl.

The term machine direction (MD) refers to the direction in which the fibrous web was manufactured. The term cross direction (CD) refers to the direction perpendicular to the machine direction.

The present disclosure refers to the bond patterns with an orthogonal frame of reference. That frame of reference has a primary direction and a secondary direction. The term primary direction refers to a first direction in that frame of reference. In the present disclosure, the primary direction is considered to be parallel to the x axis in an x-y Cartesian coordinate system. The term secondary direction refers to a second direction in that frame of reference, that is perpendicular to the primary direction. In the present disclosure, the secondary direction is considered to be parallel to the y axis in an x-y Cartesian coordinate system. However, in various embodiments, the directions in an orthogonal frame of reference can be slightly adjusted by a few degrees closer together or farther apart, such that the primary and secondary directions are not exactly 90 degrees apart from each other, but may vary within a narrow range, for example, from 80-100 degrees.

The term “Lx” refers to a largest overall dimension of a bond measured linearly in the primary direction. The term “Ly” refers to a largest overall dimension of a bond measured linearly in the secondary direction. The term “bond angle” refers to the acute angle formed between Bl and the secondary direction. A particular bond can be oriented to form a positive angle or a negative angle with respect to the secondary direction. However, for ease of reference, a bond angle is always referred to as a positive angle herein.

The term “row” refers to a series of bonds, aligned to a common reference line, wherein adjacent bonds in the row are spaced apart by a uniform distance. A primary row is a row of bonds that is parallel with the primary direction. A secondary row is a row of bonds that is parallel with the secondary direction.

The term “Sx” refers to a shortest distance, measured linearly in the primary direction, between the centers of bonds in adjacent secondary rows. The term “Sy” refers to a distance, measured linearly in the secondary direction, between the centers of adjacent bonds in the same secondary row. The term “center spacing ratio” refers to the ratio of Sy to Sx.

The term “stagger” refers to a relative secondary direction offset of bonds in adjacent secondary rows. When adjacent secondary rows are offset from each other in the secondary direction by a non-zero distance, the bonds are considered staggered. The term “reverse” refers to the relative angular orientations of bonds in adjacent secondary rows. When bonds in a row are oriented at a positive angle with respect to the secondary direction, and bonds in an adjacent row are oriented at a negative angle with respect to the secondary direction, the bonds are considered reversed.

The term “SAx” refers to a shortest distance, measured linearly in the primary direction, between adjacent bonds in the same primary row. The term “SAy” refers to a shortest distance, measured linearly in the secondary direction, between adjacent bonds in the same secondary row. The term “SNAx” refers to a shortest distance, measured linearly in the primary direction, between a bond in a secondary row and a bond in an adjacent secondary row. The term “SNAy” refers to a shortest distance, measured linearly in the secondary direction, between a bond in a primary row and a bond in an adjacent primary row.

A positive value for SAx, SAy, SNAx, or SNAy represents a gap distance between bonds. In other words, within the gap distance, a line drawn perpendicular to the relevant direction of measurement will intersect neither of the bonds. A negative value for SAx, SAy, SNAx, or SNAy represents an overlap distance between bonds. In other words, within the overlap distance, a line drawn perpendicular to the relevant direction of measurement will intersect both of the bonds. SAx, SAy, SNAx, or SNAy can also be expressed as a percent of overall length of the bond, Bl, which is a shortest distance percentage. The percent can be positive or negative, in the same way that the values can be positive or negative.

The meaning of the term “SAd” depends on the value for SNAx. If SNAx is positive, then the term “SAd” refers to a shortest distance, measured linearly in the secondary direction between the perimeters of adjacent bonds in the same secondary row. If SNAx is negative, then the term “SAd” refers to a shortest distance, measured linearly in the secondary direction between the perimeters of the closest two bonds, which may not be in the same secondary row. The term “SNAd” refers to a shortest distance, measured linearly in any direction in the plane of the bonded web, between the perimeters of the closest two bonds. SAd and SNAd may also have a negative value, which is indicative of a physical overlap between bonds. In such a case where SAd or SNAd is negative, the individual bonds in a repeating pattern then combine to form a macroscopic repeating pattern as well. The term “perimeter spacing ratio” refers to the ratio of SAd to SNAd. A negative perimeter spacing ratio is indicative of a bond pattern which has physical overlap between bonds. The term “bisect angle” refers to the acute angle formed between the line of SNAd and the primary direction. For ease of reference, each bisect angle is always referred to as a positive angle herein.

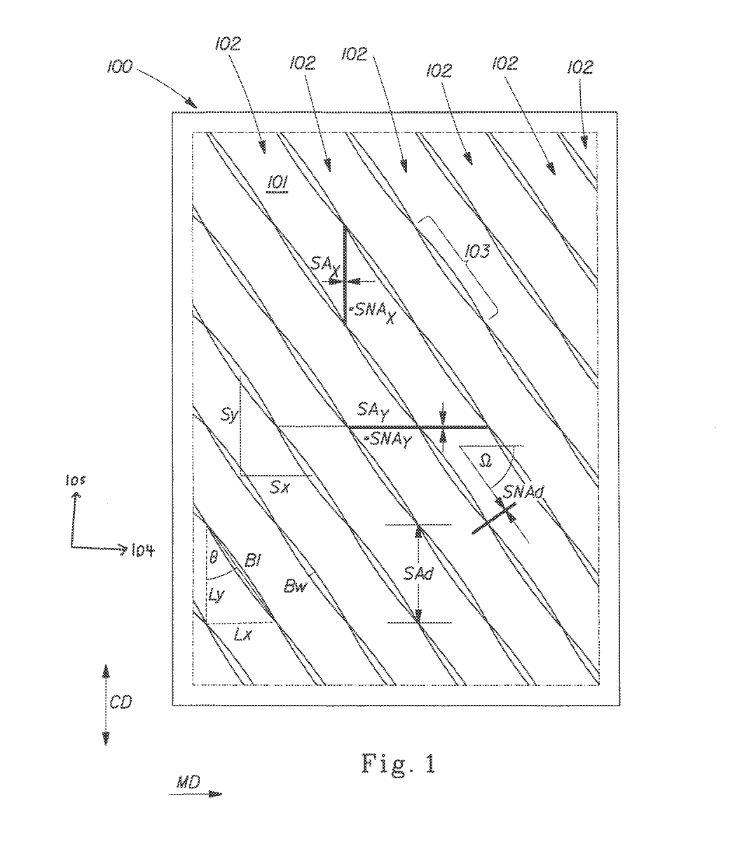

FIG. 1 is a top view of a bonded fibrous web 100 having a fibrous web 101 bonded with a first bond pattern 102 of bonds 103. The fibrous web 101 has a machine direction MD and a cross direction CD. The fibrous web 101 can be any kind of fibrous web described herein, in any size or shape.

The first bond pattern 102 has a primary direction 104 and a secondary direction 105. In the embodiment of FIG. 1, the primary direction 104 is parallel to the machine direction of the fibrous web 101 and the secondary direction 105 is parallel to the cross direction of the fibrous web 101.

The bonds 103 can be any kind of bond described herein, in any size or shape. The double-dash lines that surround the bond pattern 102 represent the bond pattern 102 as having an area of variable length and width within the fibrous web 101. The bond pattern 102 can be imparted to the fibrous web 101 using any kind of process described herein.

Each of the bonds 103 in the bond pattern 102 has an overall shape that is relatively long, thin, and curved, tapering to two ends. Each of the bonds 103 is symmetrical lengthwise and widthwise, although in some embodiments, one or more of the bonds 103 can be configured to be asymmetrical. In various embodiments, a few, or some, or substantially all, or all of the bonds 103 in the bond pattern 102 can be configured with one or more overall bond shapes as described herein, including any of the alternative embodiments. The bonds 103 uniformly repeat in the secondary direction 105 to form a row. The secondary row of the bonds 103 repeats in the primary direction 104 to form the bond pattern 102. In the bond pattern 102, adjacent secondary rows of the bonds 103 are neither staggered nor reversed with respect to each other.

Each of the bonds 103 in the bond pattern 102 has an overall length Bl of 5.00 mm and an overall width Bw of 0.25 mm, resulting in a shape ratio of 0.05. Each of the bonds 103 in the bond pattern 102 is oriented at a bond angle Θ of 35 degrees, resulting in an Lx value of 2.87 mm and an Ly value of 4.10 mm. With respect to each other, the bonds 103 in the bond pattern 102 have an Sx value of 2.79 mm and an Sy value of 4.00 mm, resulting in a center spacing ratio of 1.43. The bonds 103 in the bond pattern 102 also have an SAx value of −0.18 mm or −4%, an SAy value of −0.24 mm or −5%, an SNAx value of −0.18 mm or −4%, and an SNAy value of −0.24 mm or −5%. The bonds 103 in the bond pattern 102 further have an SAd value of 3.79 mm and an SNAd value of −0.30 mm, resulting in a perimeter spacing ratio of −12.70. The line of SNAd forms a bisect angle Ω of 55 degrees. The bond pattern 102 has a bond area of 9%.

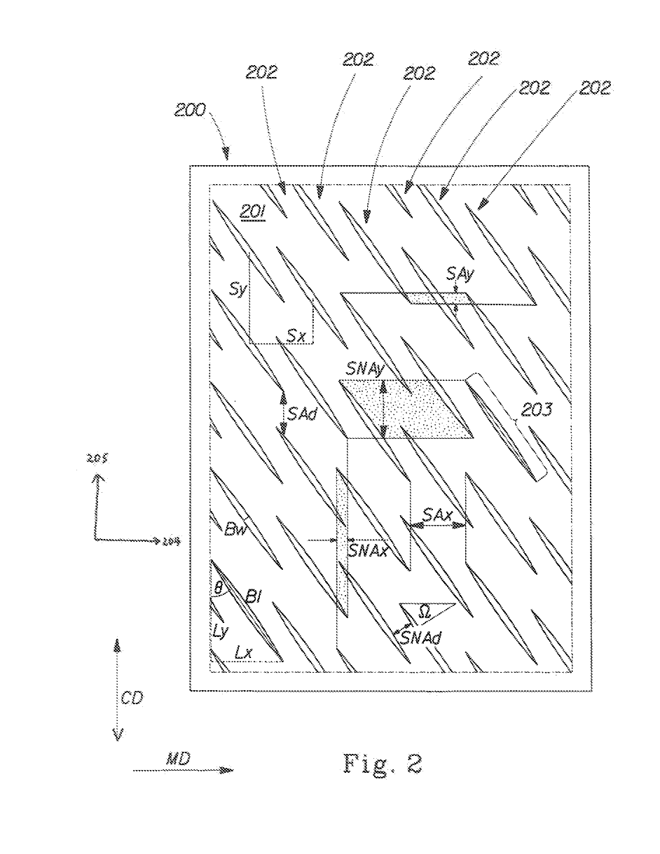

FIG. 2 is a top view of a bonded fibrous web 200 having a fibrous web 201 bonded with a second bond pattern 202 of bonds 203. The fibrous web 201 has a machine direction MD and a cross direction CD.

The second bond pattern 202 has a primary direction 204 and a secondary direction 205. In the embodiment of FIG. 2, the primary direction 204 is parallel to the machine direction of the fibrous web 201 and the secondary direction 205 is parallel to the cross direction of the fibrous web 201.

The fibrous web 201 can be any kind of fibrous web described herein, in any size or shape. The bonds 203 can be any kind of bond described herein, in any size or shape. The double-dash lines that surround the bond pattern 202 represent the bond pattern 202 as having an area of variable length and width within the fibrous web 201. The bond pattern 202 can be imparted to the fibrous web 201 using any kind of process described herein.

Each of the bonds 203 in the bond pattern 202 has an overall shape that is relatively long, thin, and curved, tapering to two ends. Each of the bonds 203 is symmetrical lengthwise and widthwise, although in some embodiments, one or more of the bonds 203 can be configured to be asymmetrical. In various embodiments, a few, or some, or substantially all, or all of the bonds 203 in the bond pattern 202 can be configured with one or more overall bond shapes as described herein, including any of the alternative embodiments. The bonds 203 uniformly repeat in the secondary direction 205 to form a row. The secondary row of the bonds 203 repeats in the primary direction 204 to form the bond pattern 202. In the bond pattern 202, adjacent secondary rows of the bonds 203 are staggered but not reversed with respect to each other. Each of the bonds 203 in the bond pattern 202 has an overall length Bl of 5.63 mm and an overall width Bw of 0.25 mm, resulting in a shape ratio of 0.04. Each of the bonds 203 in the bond pattern 202 is oriented at a bond angle Θ of 35 degrees, resulting in an Lx value of 3.23 mm and an Ly value of 4.61 mm. With respect to each other, the bonds 203 in the bond pattern 202 have an Sx value of 2.79 mm and an Sy value of 4.00 mm, resulting in a center spacing ratio of 1.43. The bonds 203 in the bond pattern 202 also have an SAx value of 2.52 mm or 45%, an SAy value of −0.57 mm or −10%, an SNAx value of −0.43 mm or −8%, and an SNAy value of −2.52 mm or −45%. The bonds 203 in the bond pattern 202 further have an SAd value of 1.83 mm and an SNAd value of 0.93 mm, resulting in a perimeter spacing ratio of 1.98. The line of SNAd forms a bisect angle Ω of 41.5 degrees. The bond pattern 202 has a bond area of 10%.

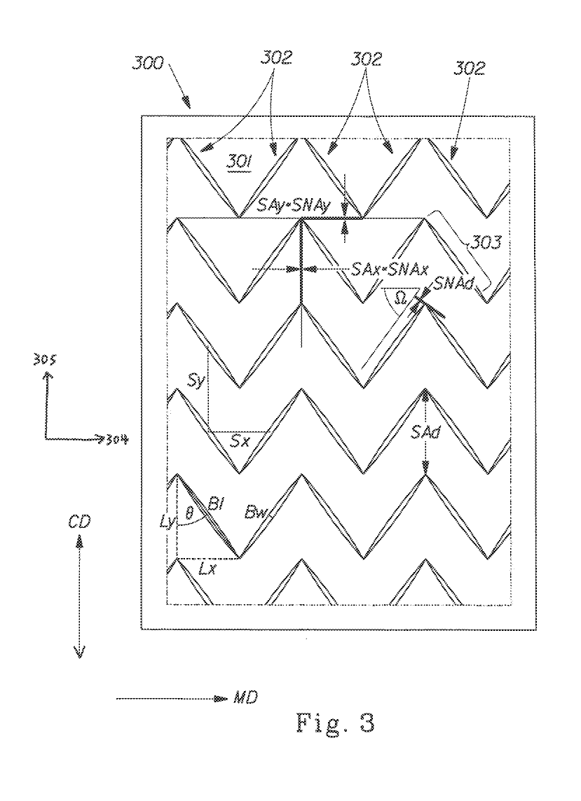

FIG. 3 is a top view of a bonded fibrous web 300 having a fibrous web 301 bonded with a third bond pattern 302 of bonds 303. The fibrous web 301 has a machine direction MD and a cross direction CD.

The third bond pattern 302 has a primary direction 304 and a secondary direction 305. In the embodiment of FIG. 3, the primary direction 304 is parallel to the machine direction of the fibrous web 301 and the secondary direction 305 is parallel to the cross direction of the fibrous web 301.

The fibrous web 301 can be any kind of fibrous web described herein, in any size or shape. The bonds 303 can be any kind of bond described herein, in any size or shape. The double-dash lines that surround the bond pattern 302 represent the bond pattern 302 as having an area of variable length and width within the fibrous web 301. The bond pattern 302 can be imparted to the fibrous web 301 using any kind of process described herein.

Each of the bonds 303 in the bond pattern 302 has an overall shape that is relatively long, thin, and curved, tapering to two ends. Each of the bonds 303 is symmetrical lengthwise and widthwise, although in some embodiments, one or more of the bonds 303 can be configured to be asymmetrical. In various embodiments, a few, or some, or substantially all, or all of the bonds 303 in the bond pattern 302 can be configured with one or more overall bond shapes as described herein, including any of the alternative embodiments. The bonds 303 uniformly repeat in the secondary direction 305 to form a row. The secondary row of the bonds 303 repeats in the primary direction 304 to form the bond pattern 302. In the bond pattern 302, adjacent secondary rows of the bonds 303 are not staggered but are reversed with respect to each other. In the bond pattern 302, adjacent secondary rows are reversed at equal but opposite angles; that is, in terms of bond angle, the reversed bonds are mirrored by the secondary direction 305.

Each of the bonds 303 in the bond pattern 302 has an overall length Bl of 5.00 mm and an overall width Bw of 0.25 mm, resulting in a shape ratio of 0.05. Each of the bonds 303 in the bond pattern 302 is oriented at a bond angle Θ of 35 degrees, resulting in an Lx value of 2.87 mm and an Ly value of 4.10 mm. With respect to each other, the bonds 303 in the bond pattern 302 have an Sx value of 2.79 mm and an Sy value of 4.00 mm, resulting in a center spacing ratio of 1.43. The bonds 303 in the bond pattern 302 also have an SAx value of −0.18 mm or −4%, an SAy value of −0.24 mm or −5%, an SNAx value of −0.18 mm or −4%, and an SNAy value of −0.24 mm or −5%. The bonds 303 in the bond pattern 302 further have an SAd value of 3.76 mm and an SNAd value of −0.31 mm, resulting in a perimeter spacing ratio of −12.29. The line of SNAd forms a bisect angle Ω of 55 degrees. The bond pattern 302 has a bond area of 9%.

FIG. 4 is a top view of a bonded fibrous web 400 having a fibrous web 401 bonded with a fourth bond pattern 402 of bonds 403. The fibrous web 401 has a machine direction MD and a cross direction CD.

The fourth bond pattern 402 has a primary direction 404 and a secondary direction 405. In the embodiment of FIG. 4, the primary direction 404 is parallel to the machine direction of the fibrous web 401 and the secondary direction 405 is parallel to the cross direction of the fibrous web 401.

The fibrous web 401 can be any kind of fibrous web described herein, in any size or shape. The bonds 403 can be any kind of bond described herein, in any size or shape. The double-dash lines that surround the bond pattern 402 represent the bond pattern 402 as having an area of variable length and width within the fibrous web 401. The bond pattern 402 can be imparted to the fibrous web 401 using any kind of process described herein.

Each of the bonds 403 in the bond pattern 402 has an overall shape that is relatively long, thin, and curved, tapering to two ends. Each of the bonds 403 is symmetrical lengthwise and widthwise, although in some embodiments, one or more of the bonds 403 can be configured to be asymmetrical. In various embodiments, a few, or some, or substantially all, or all of the bonds 403 in the bond pattern 402 can be configured with one or more overall bond shapes as described herein, including any of the alternative embodiments. The bonds 403 uniformly repeat in the secondary direction 405 to form a row. The secondary row of the bonds 403 repeats in the primary direction 404 to form the bond pattern 402. In the bond pattern 402, adjacent secondary rows of the bonds 403 are staggered and reversed with respect to each other. In the bond pattern 402, adjacent secondary rows are reversed at equal but opposite angles; that is, in terms of bond angle, the reversed bonds are mirrored by the secondary direction 405.

Each of the bonds 403 in the bond pattern 402 has an overall length Bl of 5.63 mm and an overall width Bw of 0.25 mm, resulting in a shape ratio of 0.04. Each of the bonds 403 in the bond pattern 402 is oriented at a bond angle Θ of 35 degrees, resulting in an Lx value of 3.23 mm and an Ly value of 4.61 mm. With respect to each other, the bonds 403 in the bond pattern 402 have an Sx value of 2.79 mm and an Sy value of 4.00 mm, resulting in a center spacing ratio of 1.43. The bonds 403 in the bond pattern 402 also have an SAx value of 2.35 mm or 42%, an SAy value of −0.61 mm or −11%, an SNAx value of −0.44 mm or −8%, and an SNAy value of −2.06 mm or −37%. The bonds 403 in the bond pattern 402 further have an SAd value of 1.31 mm and an SNAd value of 0.80 mm, resulting in a perimeter spacing ratio of 1.64. The line of SNAd forms a bisect angle Ω of 55 degrees. The bond pattern 402 has a bond area of 10%.

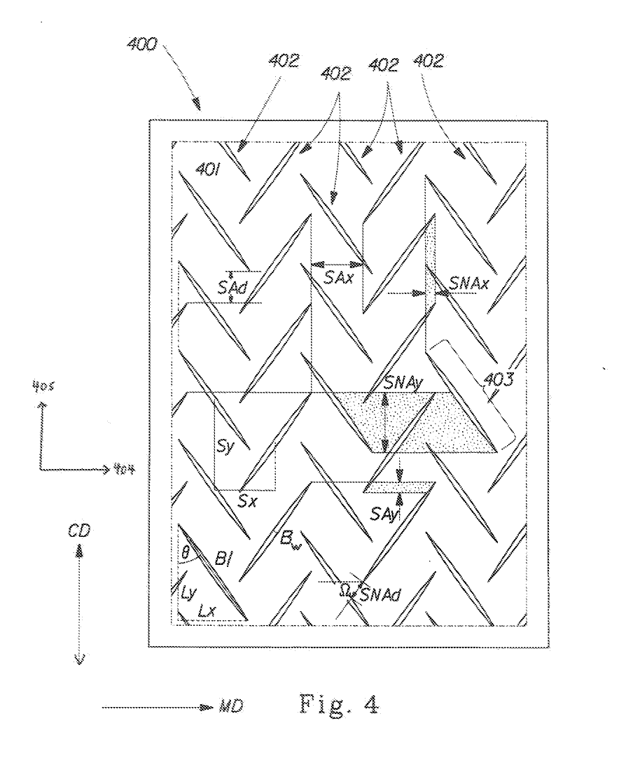

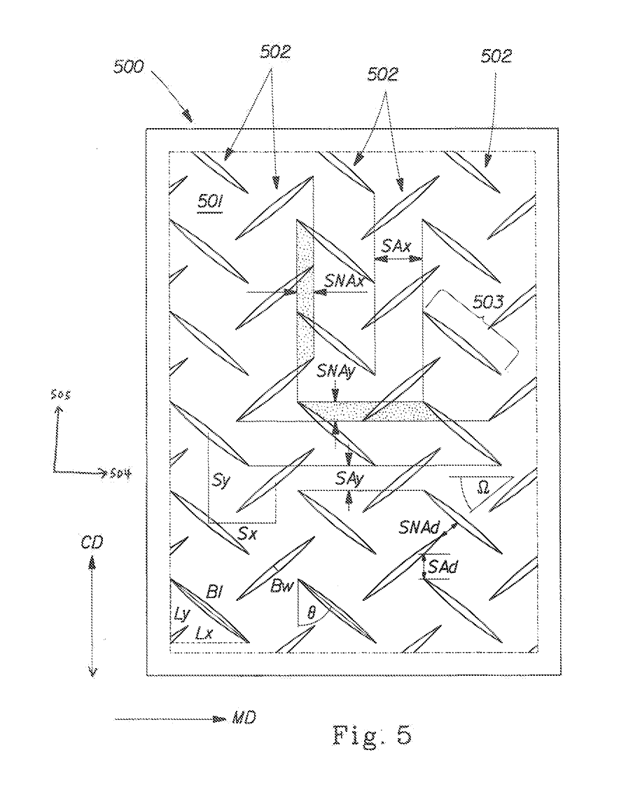

FIG. 5 is a top view of a bonded fibrous web 500 having a fibrous web 501 bonded with a fifth bond pattern 502 of bonds 503. The fibrous web 501 has a machine direction MD and a cross direction CD.

The fifth bond pattern 502 has a primary direction 504 and a secondary direction 505. In the embodiment of FIG. 5, the primary direction 504 is parallel to the machine direction of the fibrous web 501 and the secondary direction 505 is parallel to the cross direction of the fibrous web 501.

The fibrous web 501 can be any kind of fibrous web described herein, in any size or shape. The bonds 503 can be any kind of bond described herein, in any size or shape. The double-dash lines that surround the bond pattern 502 represent the bond pattern 502 as having an area of variable length and width within the fibrous web 501. The bond pattern 502 can be imparted to the fibrous web 501 using any kind of process described herein.

Each of the bonds 503 in the bond pattern 502 has an overall shape that is relatively long, thin, and curved, tapering to two ends. Each of the bonds 503 is symmetrical lengthwise and widthwise, although in some embodiments, one or more of the bonds 503 can be configured to be asymmetrical. In various embodiments, a few, or some, or substantially all, or all of the bonds 503 in the bond pattern 502 can be configured with one or more overall bond shapes as described herein, including any of the alternative embodiments. The bonds 503 uniformly repeat in the secondary direction 505 to form a row. The secondary row of the bonds 503 repeats in the primary direction 504 to form the bond pattern 502. In the bond pattern 502, adjacent secondary rows of the bonds 503 are staggered and reversed with respect to each other. In the bond pattern 502, adjacent secondary rows are reversed at equal but opposite angles; that is, in terms of bond angle, the reversed bonds are mirrored by the secondary direction 505.

Each of the bonds 503 in the bond pattern 502 has an overall length Bl of 4.31 mm and an overall width Bw of 0.25 mm, resulting in a shape ratio of 0.06. Each of the bonds 503 in the bond pattern 502 is oriented at a bond angle Θ of 50 degrees, resulting in an Lx value of 3.30 mm and an Ly value of 2.77 mm. With respect to each other, the bonds 503 in the bond pattern 502 have an Sx value of 2.79 mm and an Sy value of 4.00 mm, resulting in a center spacing ratio of 1.43. The bonds 503 in the bond pattern 502 also have an SAx value of 2.28 mm or 53%, an SAy value of −1.23 mm or 28%, an SNAx value of −0.47 mm or −11%, and an SNAy value of −0.69 mm or −16%. The bonds 503 in the bond pattern 502 further have an SAd value of 1.47 mm and an SNAd value of 1.05 mm, resulting in a perimeter spacing ratio of 1.39. The line of SNAd forms a bisect angle Ω of 40 degrees. The bond pattern 502 has a bond area of 8%.

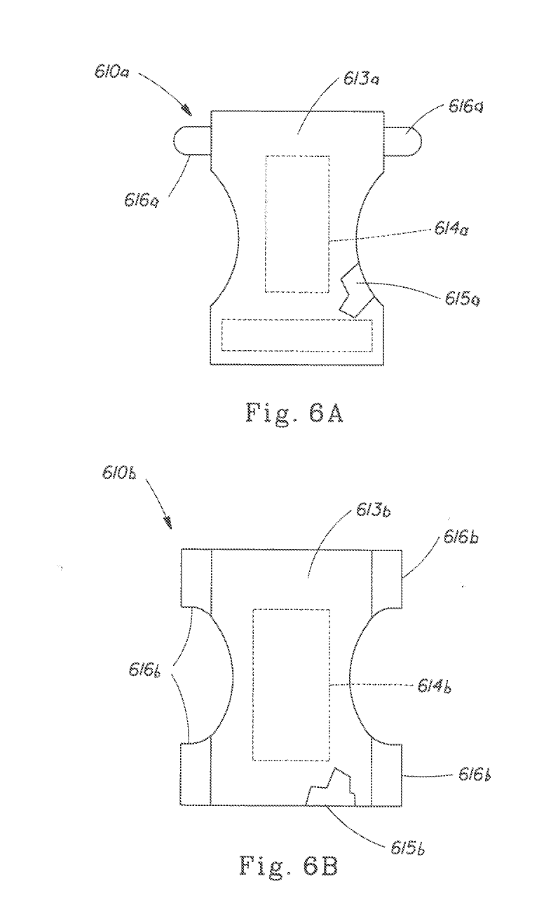

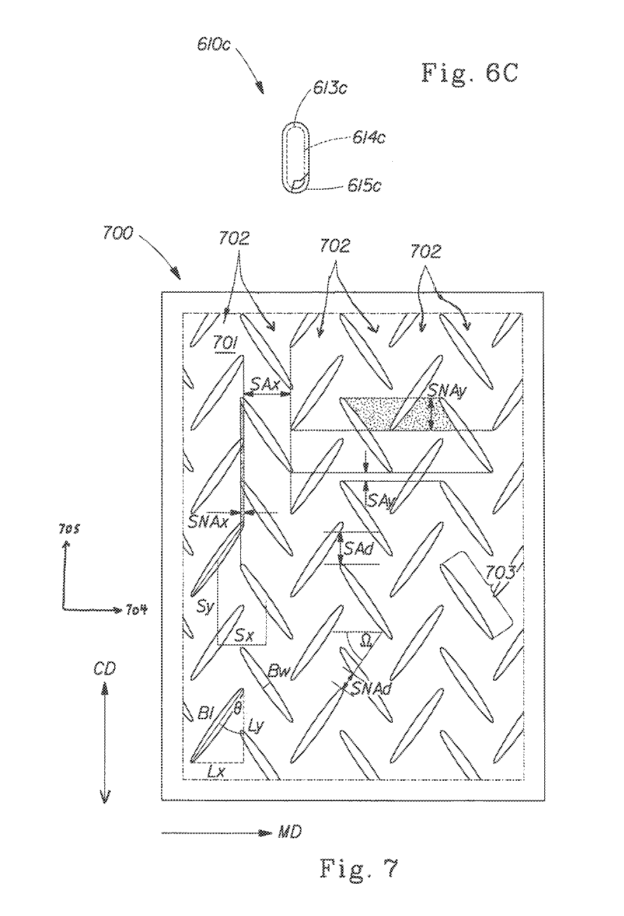

FIG. 6A is an inside plan view illustrating a front-fastenable wearable absorbent article 610a. The present disclosure contemplates that, a model of an absorbent article that is configured to be front-fastenable can also be configured to be rear fastenable or side-fastenable, as will be understood by one of ordinary skill in the art.

The front-fastenable wearable absorbent article 610a includes a wearer-facing external surface 613a, a garment-facing external surface 615a, an absorbent core 614a, and side ears 616a. The absorbent core 614a is disposed between the wearer-facing external surface 613a and the garment-facing external surface 615a. The side ears 616 are disposed on the sides of the front-fastenable wearable absorbent article 610a.

The wearer-facing external surface 613a is a layer of one or more materials that form at least a portion of an inside of the front-fastenable wearable absorbent article and faces a wearer when the absorbent article 610a is worn by the wearer. In FIG. 6A, a portion of the wearer-facing external surface 613a is illustrated as broken-away, in order to show the garment-facing external surface 615a. A wearer-facing external surface is sometimes referred to as a topsheet. The wearer-facing external surface 613a is configured to be liquid permeable, such that bodily fluids received by the absorbent article 610a can pass through the wearer-facing external surface 613a to the absorbent core 614a. In various embodiments, a wearer-facing external surface can include one or more fibrous webs having one or more bond patterns of the present disclosure.

The absorbent core 614a is disposed subjacent to the wearer-facing external surface 613a and superjacent to the garment-facing external surface 615a, in at least a portion of the absorbent article 610a. An absorbent core 614a can include absorbent material and one or more fibrous webs having one or more bond patterns of the present disclosure. Fibrous webs of an absorbent core are sometimes referred to as an acquisition layer, a distribution layer, a core cover, and a dusting layer. The absorbent material is configured to be liquid absorbent, and can absorb bodily fluids received by the absorbent article 610a. In various embodiments, an absorbent material can include wood pulp, or super absorbent polymers (SAP), or another kind of absorbent material, or any combinations of any of these materials.

The garment-facing external surface 615a is a layer of one or more materials that form at least a portion of an outside of the front-fastenable wearable absorbent article and faces a wearer's garments when the absorbent article 610a is worn by the wearer. A garment-facing external surface is sometimes referred to as a backsheet. The garment-facing external surface 615a is configured to be liquid impermeable, such that bodily fluids received by the absorbent article 610a cannot pass through the garment-facing external surface 613a. In various embodiments, a garment-facing external surface can include one or more fibrous webs having one or more bond patterns of the present disclosure. The side ears 616A can also include one or more fibrous webs having one or more bond patterns of the present disclosure.

FIG. 6B is an inside plan view illustrating a pant-type wearable absorbent article 610B. The present disclosure contemplates that, a model of an absorbent article that is configured to be pant-type can be configured to be side-fastenable or without fasteners, as will be understood by one of ordinary skill in the art.

The pant-type wearable absorbent article 610b includes a wearer-facing external surface 610b, a garment-facing external surface 615B, and an absorbent core 614b, each of which can be generally configured in the same manner as the like-numbered element in the embodiment of FIG. 6a. The pant-type wearable absorbent article 610b also includes side panels 616b disposed on the sides of the pant-type wearable absorbent article 610a. The side panels 616b can include one or more fibrous webs having one or more bond patterns of the present disclosure.

FIG. 6C is an inside plan view illustrating a feminine pad absorbent article 610C. The feminine pad absorbent article 610C includes a wearer-facing external surface 613C, a garment-facing external surface 615C, and an absorbent core 614C, each of which can be configured in a manner similar to the like-numbered element in the embodiments of FIGS. 6A and 6B.

FIG. 7 is a top view of a bonded fibrous web 700 having a fibrous web 701 bonded with a seventh bond pattern 702 of bonds 703. The fibrous web 701 has a machine direction MD and a cross direction CD.

The seventh bond pattern 702 has a primary direction 704 and a secondary direction 705. In the embodiment of FIG. 7, the primary direction 704 is parallel to the machine direction of the fibrous web 701 and the secondary direction 705 is parallel to the cross direction of the fibrous web 701.

The fibrous web 701 can be any kind of fibrous web described herein, in any size or shape. The bonds 703 can be any kind of bond described herein, in any size or shape. The double-dash lines that surround the bond pattern 702 represent the bond pattern 702 as having an area of variable length and width within the fibrous web 701. The bond pattern 702 can be imparted to the fibrous web 701 using any kind of process described herein.

Each of the bonds 703 in the bond pattern 702 has an overall shape that is relatively long, thin, and curved, tapering to two ends. Each of the bonds 703 is symmetrical lengthwise and widthwise, although in some embodiments, one or more of the bonds 703 can be configured to be asymmetrical. In various embodiments, a few, or some, or substantially all, or all of the bonds 703 in the bond pattern 702 can be configured with one or more overall bond shapes as described herein, including any of the alternative embodiments. The bonds 703 uniformly repeat in the secondary direction to form a row. The secondary row of the bonds 703 repeats in the primary direction to form the bond pattern 702. In the bond pattern 702, adjacent secondary rows of the bonds 703 are staggered and reversed with respect to each other. In the bond pattern 702, adjacent secondary rows are reversed at equal but opposite angles; that is, in terms of bond angle, the reversed bonds are mirrored by the secondary direction.

Each of the bonds 703 in the bond pattern 702 has an overall length Bl of 4.00 mm and an overall width Bw of 0.40 mm, resulting in a shape ratio of 0.10. Each of the bonds 703 in the bond pattern 702 is oriented at a bond angle Θ of 35 degrees, resulting in an Lx value of 2.29 mm and an Ly value of 3.28 mm. With respect to each other, the bonds 703 in the bond pattern 702 have an Sx value of 2.14 mm and an Sy value of 3.60 mm, resulting in a center spacing ratio of 1.68. The bonds 703 in the bond pattern 702 also have an SAx value of 1.99 mm or 50%, an SAy value of −0.32 mm or 8%, an SNAx value of −0.21 mm or −5%, and an SNAy value of −1.46 mm or −37%. The bonds 703 in the bond pattern 702 further have an SAd value of 1.43 mm and an SNAd value of 0.77 mm, resulting in a perimeter spacing ratio of 1.87. The line of SNAd forms a bisect angle Ω of 55 degrees. The bond pattern 702 has a bond area of 16%.

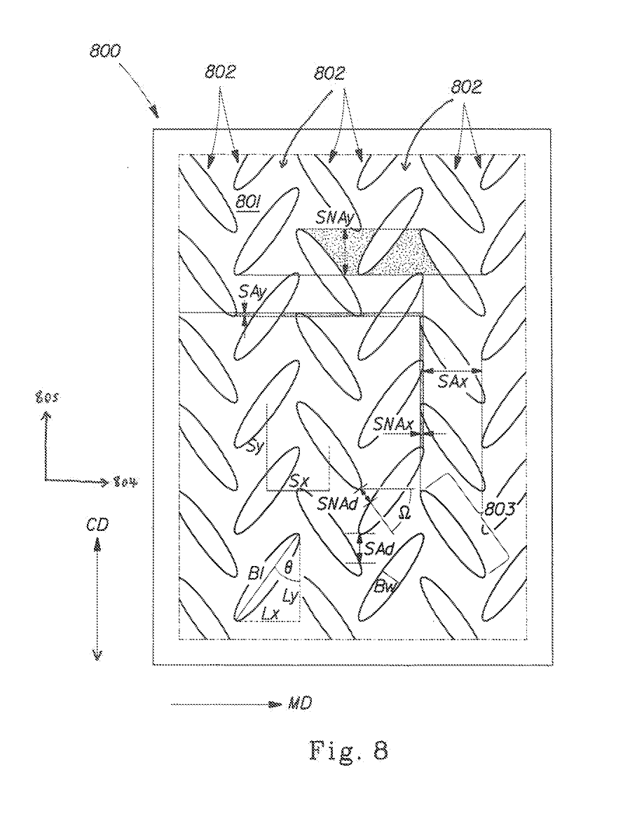

FIG. 8 is a top view of a bonded fibrous web 800 having a fibrous web 801 bonded with an eighth bond pattern 802 of bonds 803. The fibrous web 801 has a machine direction MD and a cross direction CD.

The eighth bond pattern 802 has a primary direction 804 and a secondary direction 805. In the embodiment of FIG. 8, the primary direction 804 is parallel to the machine direction of the fibrous web 801 and the secondary direction 805 is parallel to the cross direction of the fibrous web 801.

The fibrous web 801 can be any kind of fibrous web described herein, in any size or shape. The bonds 803 can be any kind of bond described herein, in any size or shape. The double-dash lines that surround the bond pattern 802 represent the bond pattern 802 as having an area of variable length and width within the fibrous web 801. The bond pattern 802 can be imparted to the fibrous web 801 using any kind of process described herein.

Each of the bonds 803 in the bond pattern 802 has an overall shape that is relatively long, thin, and curved, tapering to two ends. Each of the bonds 803 is symmetrical lengthwise and widthwise, although in some embodiments, one or more of the bonds 803 can be configured to be asymmetrical. In various embodiments, a few, or some, or substantially all, or all of the bonds 803 in the bond pattern 802 can be configured with one or more overall bond shapes as described herein, including any of the alternative embodiments. The bonds 803 uniformly repeat in the secondary direction 805 to form a row. The secondary row of the bonds 803 repeats in the primary direction 804 to form the bond pattern 802. In the bond pattern 802, adjacent secondary rows of the bonds 803 are staggered and reversed with respect to each other. In the bond pattern 802, adjacent secondary rows are reversed at equal but opposite angles; that is, in terms of bond angle, the reversed bonds are mirrored by the secondary direction 805.

Each of the bonds 803 in the bond pattern 802 has an overall length Bl of 2.00 mm and an overall width Bw of 0.40 mm, resulting in a shape ratio of 0.20. Each of the bonds 803 in the bond pattern 802 is oriented at a bond angle Θ of 35 degrees, resulting in an Lx value of 1.15 mm and an Ly value of 1.64 mm. With respect to each other, the bonds 803 in the bond pattern 802 have an Sx value of 1.13 mm and an Sy value of 1.60 mm, resulting in a center spacing ratio of 1.42. The bonds 803 in the bond pattern 802 also have an SAx value of 1.11 mm or 56%, an SAy value of −0.04 mm or −2%, an SNAx value of −0.07 mm or −4%, and an SNAy value of −0.80 mm or −40%. The bonds 803 in the bond pattern 802 further have an SAd value of 0.54 mm and an SNAd value of 0.27 mm, resulting in a perimeter spacing ratio of 1.97. The line of SNAd forms a bisect angle Ω of 55 degrees. The bond pattern 802 has a bond area of 34%.

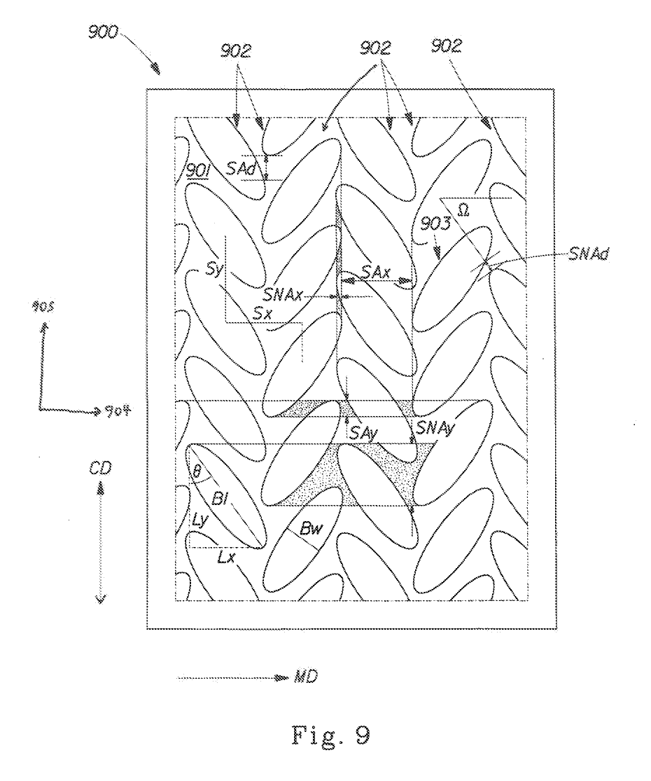

FIG. 9 is a top view of a bonded fibrous web 900 having a fibrous web 901 bonded with a ninth bond pattern 902 of bonds 903. The fibrous web 901 has a machine direction MD and a cross direction CD.

The ninth bond pattern 902 has a primary direction 904 and a secondary direction 905. In the embodiment of FIG. 9, the primary direction 904 is parallel to the machine direction of the fibrous web 901 and the secondary direction 905 is parallel to the cross direction of the fibrous web 901.

The fibrous web 901 can be any kind of fibrous web described herein, in any size or shape. The bonds 903 can be any kind of bond described herein, in any size or shape. The double-dash lines that surround the bond pattern 902 represent the bond pattern 902 as having an area of variable length and width within the fibrous web 901. The bond pattern 902 can be imparted to the fibrous web 901 using any kind of process described herein.

Each of the bonds 903 in the bond pattern 902 has an overall shape similar to an elongated oval, with two ends. Each of the bonds 903 is symmetrical lengthwise and widthwise, although in some embodiments, one or more of the bonds 903 can be configured to be asymmetrical. In various embodiments, a few, or some, or substantially all, or all of the bonds 903 in the bond pattern 902 can be configured with one or more overall bond shapes as described herein, including any of the alternative embodiments. The bonds 903 uniformly repeat in the secondary direction 905 to form a row. The secondary row of the bonds 903 repeats in the primary direction 904 to form the bond pattern 902. In the bond pattern 902, adjacent secondary rows of the bonds 903 are staggered and reversed with respect to each other. In the bond pattern 902, adjacent secondary rows are reversed at equal but opposite angles; that is, in terms of bond angle, the reversed bonds are mirrored by the secondary direction 905.

Each of the bonds 903 in the bond pattern 902 has an overall length Bl of 1.30 mm and an overall width Bw of 0.40 mm, resulting in a shape ratio of 0.31. Each of the bonds 903 in the bond pattern 902 is oriented at a bond angle Θ of 35 degrees, resulting in an Lx value of 0.75 mm and an Ly value of 1.07 mm. With respect to each other, the bonds 903 in the bond pattern 902 have an Sx value of 0.78 mm and an Sy value of 0.90 mm, resulting in a center spacing ratio of 1.15. The bonds 903 in the bond pattern 902 also have an SAx value of 0.81 mm or 63%, an SAy value of −0.16 mm or −13%, an SNAx value of −0.05 mm or −4%, and an SNAy value of −0.62 mm or −48%. The bonds 903 in the bond pattern 902 further have an SAd value of 0.30 mm and an SNAd value of 0.11 mm, resulting in a perimeter spacing ratio of 2.62. The line of SNAd forms a bisect angle Ω of 55 degrees. The bond pattern 902 has a bond area of 54%.

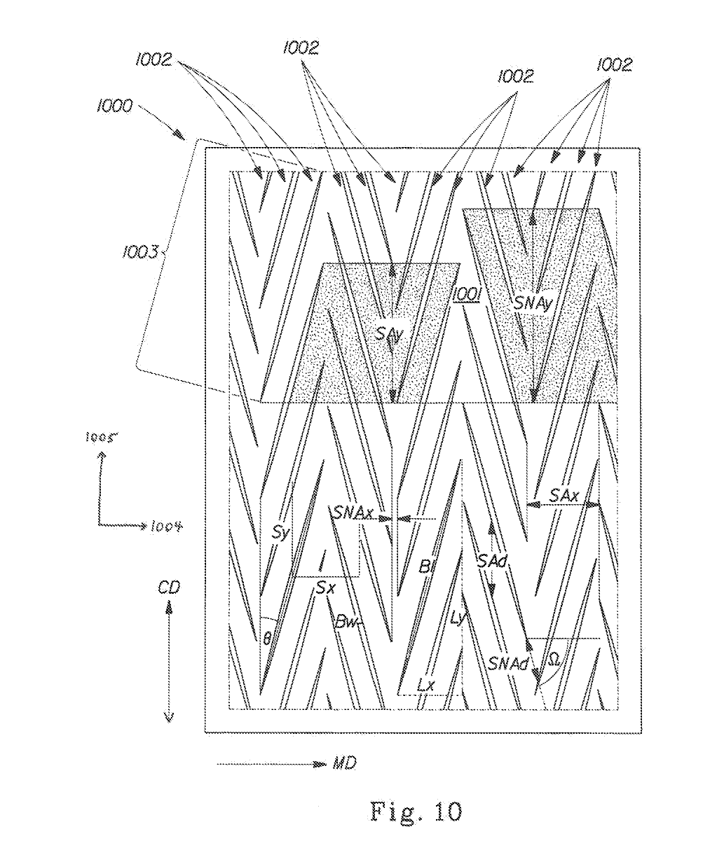

FIG. 10 is a top view of a bonded fibrous web 1000 having a fibrous web 1001 bonded with a tenth bond pattern 1002 of bonds 1003. The fibrous web 1001 has a machine direction MD and a cross direction CD.

The tenth bond pattern 1002 has a primary direction 1004 and a secondary direction 1005. In the embodiment of FIG. 10, the primary direction 1004 is parallel to the machine direction of the fibrous web 1001 and the secondary direction 1005 is parallel to the cross direction of the fibrous web 1001.

The fibrous web 1001 can be any kind of fibrous web described herein, in any size or shape. The bonds 1003 can be any kind of bond described herein, in any size or shape. The double-dash lines that surround the bond pattern 1002 represent the bond pattern 1002 as having an area of variable length and width within the fibrous web 1001. The bond pattern 1002 can be imparted to the fibrous web 1001 using any kind of process described herein.

Each of the bonds 1003 in the bond pattern 1002 has an overall shape that is relatively long, thin, and curved, tapering to two ends. Each of the bonds 1003 is symmetrical lengthwise and widthwise, although in some embodiments, one or more of the bonds 1003 can be configured to be asymmetrical. In various embodiments, a few, or some, or substantially all, or all of the bonds 1003 in the bond pattern 1002 can be configured with one or more overall bond shapes as described herein, including any of the alternative embodiments. The bonds 1003 uniformly repeat in the secondary direction 1005 to form a row. The secondary row of the bonds 1003 repeats in the primary direction 1004 to form the bond pattern 1002. In the bond pattern 1002, adjacent secondary rows of the bonds 1003 are staggered and reversed with respect to each other. In the bond pattern 1002, adjacent secondary rows are reversed at equal but opposite angles; that is, in terms of bond angle, the reversed bonds are mirrored by the secondary direction 1005.

Each of the bonds 1003 in the bond pattern 1002 has an overall length Bl of 10.27 mm and an overall width Bw of 0.25 mm, resulting in a shape ratio of 0.02. Each of the bonds 1003 in the bond pattern 1002 is oriented at a bond angle Θ of 15 degrees, resulting in an Lx value of 2.66 mm and an Ly value of 9.92 mm. With respect to each other, the bonds 1003 in the bond pattern 1002 have an Sx value of 2.79 mm and an Sy value of 4.00 mm, resulting in a center spacing ratio of 1.43. The bonds 1003 in the bond pattern 1002 also have an SAx value of 2.92 mm or 28%, an SAy value of −5.92 mm or −58%, an SNAx value of 0.17 mm or 2%, and an SNAy value of −7.91 mm or −77%. The bonds 1003 in the bond pattern 1002 further have an SAd value of 3.11 mm and an SNAd value of 1.10 mm, resulting in a perimeter spacing ratio of 2.82. The line of SNAd forms a bisect angle Ω of 75 degrees. The bond pattern 1002 has a bond area of 18%.

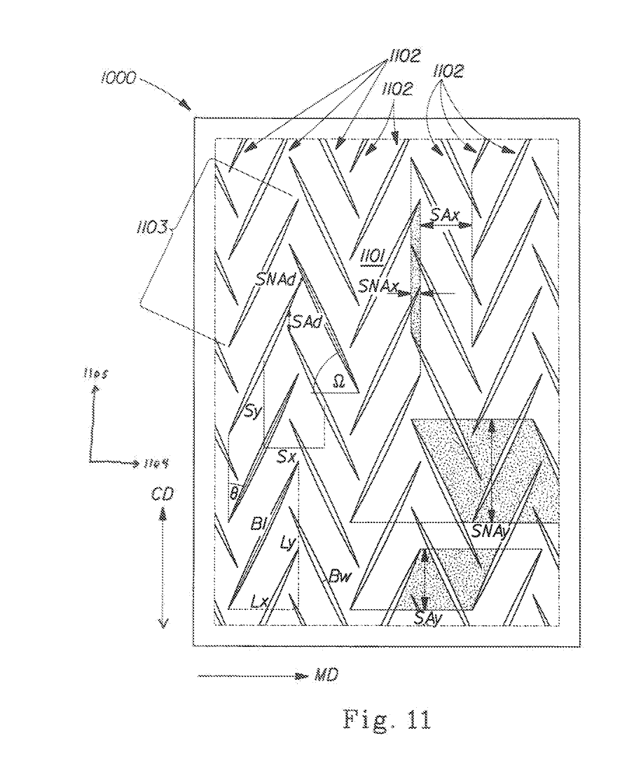

FIG. 11 is a top view of a bonded fibrous web 1100 having a fibrous web 1101 bonded with an eleventh bond pattern 1102 of bonds 1103. The fibrous web 1101 has a machine direction MD and a cross direction CD.

The eleventh bond pattern 1102 has a primary direction 1104 and a secondary direction 1105. In the embodiment of FIG. 11, the primary direction 1104 is parallel to the machine direction of the fibrous web 1101 and the secondary direction 1105 is parallel to the cross direction of the fibrous web 1101.

The fibrous web 1101 can be any kind of fibrous web described herein, in any size or shape. The bonds 1103 can be any kind of bond described herein, in any size or shape. The double-dash lines that surround the bond pattern 1102 represent the bond pattern 1102 as having an area of variable length and width within the fibrous web 1101. The bond pattern 1102 can be imparted to the fibrous web 1101 using any kind of process described herein.

Each of the bonds 1103 in the bond pattern 1102 has an overall shape that is relatively long, thin, and curved, tapering to two ends. Each of the bonds 1103 is symmetrical lengthwise and widthwise, although in some embodiments, one or more of the bonds 1103 can be configured to be asymmetrical. In various embodiments, a few, or some, or substantially all, or all of the bonds 1103 in the bond pattern 1102 can be configured with one or more overall bond shapes as described herein, including any of the alternative embodiments. The bonds 1103 uniformly repeat in the secondary direction 1105 to form a row. The secondary row of the bonds 1103 repeats in the primary direction 1104 to form the bond pattern 1102. In the bond pattern 1102, adjacent secondary rows of the bonds 1103 are staggered and reversed with respect to each other. In the bond pattern 1102, adjacent secondary rows are reversed at equal but opposite angles; that is, in terms of bond angle, the reversed bonds are mirrored by the secondary direction 1105.

Each of the bonds 1103 in the bond pattern 1102 has an overall length Bl of 7.62 mm and an overall width Bw of 0.25 mm, resulting in a shape ratio of 0.03. Each of the bonds 1103 in the bond pattern 1102 is oriented at a bond angle Θ of 25 degrees, resulting in an Lx value of 3.22 mm and an Ly value of 6.91 mm. With respect to each other, the bonds 1103 in the bond pattern 1102 have an Sx value of 2.79 mm and an Sy value of 4.00 mm, resulting in a center spacing ratio of 1.43. The bonds 1103 in the bond pattern 1102 also have an SAx value of 2.36 mm or 31%, an SAy value of −2.91 mm or −38%, an SNAx value of −0.38 mm or −5%, and an SNAy value of −4.83 mm or −63%. The bonds 1103 in the bond pattern 1102 further have an SAd value of 0.88 mm and an SNAd value of 0.46 mm, resulting in a perimeter spacing ratio of 1.93. The line of SNAd forms a bisect angle Ω of 65 degrees. The bond pattern 1102 has a bond area of 15%.

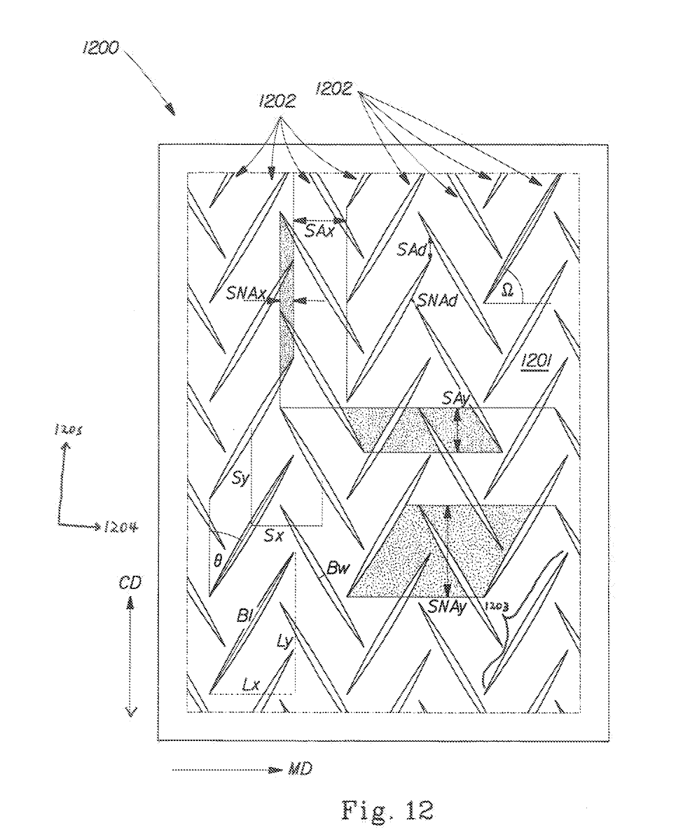

FIG. 12 is a top view of a bonded fibrous web 1200 having a fibrous web 1201 bonded with a twelfth bond pattern 1202 of bonds 1203. The fibrous web 1201 has a machine direction MD and a cross direction CD.

The twelfth bond pattern 1202 has a primary direction 1204 and a secondary direction 1205. In the embodiment of FIG. 12, the primary direction 1204 is parallel to the machine direction of the fibrous web 1201 and the secondary direction 1205 is parallel to the cross direction of the fibrous web 1201.

The fibrous web 1201 can be any kind of fibrous web described herein, in any size or shape. The bonds 1203 can be any kind of bond described herein, in any size or shape. The double-dash lines that surround the bond pattern 1202 represent the bond pattern 1202 as having an area of variable length and width within the fibrous web 1201. The bond pattern 1202 can be imparted to the fibrous web 1201 using any kind of process described herein.

Each of the bonds 1203 in the bond pattern 1202 has an overall shape that is relatively long, thin, and curved, tapering to two ends. Each of the bonds 1203 is symmetrical lengthwise and widthwise, although in some embodiments, one or more of the bonds 1203 can be configured to be asymmetrical. In various embodiments, a few, or some, or substantially all, or all of the bonds 1203 in the bond pattern 1202 can be configured with one or more overall bond shapes as described herein, including any of the alternative embodiments. The bonds 1203 uniformly repeat in the secondary direction 1205 to form a row. The secondary row of the bonds 1203 repeats in the primary direction 1204 to form the bond pattern 1202. In the bond pattern 1202, adjacent secondary rows of the bonds 1203 are staggered and reversed with respect to each other. In the bond pattern 1202, adjacent secondary rows are reversed at equal but opposite angles; that is, in terms of bond angle, the reversed bonds are mirrored by the secondary direction 1205.

Each of the bonds 1203 in the bond pattern 1202 has an overall length Bl of 6.78 mm and an overall width Bw of 0.25 mm, resulting in a shape ratio of 0.04. Each of the bonds 1203 in the bond pattern 1202 is oriented at a bond angle Θ of 30 degrees, resulting in an Lx value of 3.39 mm and an Ly value of 5.87 mm. With respect to each other, the bonds 1203 in the bond pattern 1202 have an Sx value of 2.79 mm and an Sy value of 4.00 mm, resulting in a center spacing ratio of 1.43. The bonds 1203 in the bond pattern 1202 also have an SAx value of 2.19 mm or 32%, an SAy value of −1.87 mm or −28%, an SNAx value of −0.56 mm or −8%, and an SNAy value of −3.87 mm or −57%. The bonds 1203 in the bond pattern 1202 further have an SAd value of 0.75 mm and an SNAd value of 0.45 mm, resulting in a perimeter spacing ratio of 1.69. The line of SNAd forms a bisect angle Ω of 60 degrees. The bond pattern 1202 has a bond area of 13%.

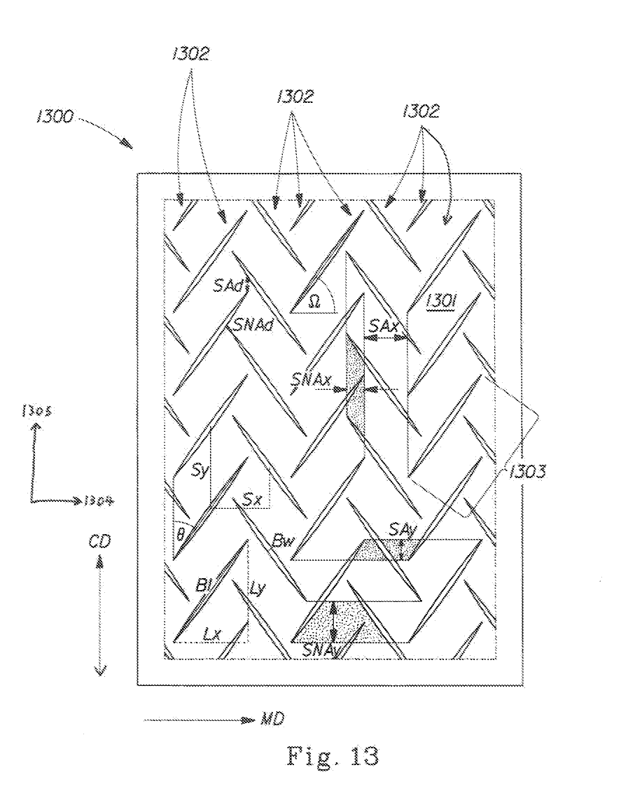

FIG. 13 is a top view of a bonded fibrous web 1300 having a fibrous web 1301 bonded with a thirteenth bond pattern 1302 of bonds 1303. The fibrous web 1301 has a machine direction MD and a cross direction CD.

The thirteenth bond pattern 1302 has a primary direction 1304 and a secondary direction 1305. In the embodiment of FIG. 13, the primary direction 1304 is parallel to the machine direction of the fibrous web 1301 and the secondary direction 1305 is parallel to the cross direction of the fibrous web 1301.

The fibrous web 1301 can be any kind of fibrous web described herein, in any size or shape. The bonds 1303 can be any kind of bond described herein, in any size or shape. The double-dash lines that surround the bond pattern 1302 represent the bond pattern 1302 as having an area of variable length and width within the fibrous web 1301. The bond pattern 1302 can be imparted to the fibrous web 1301 using any kind of process described herein.

Each of the bonds 1303 in the bond pattern 1302 has an overall shape that is relatively long, thin, and curved, tapering to two ends. Each of the bonds 1303 is symmetrical lengthwise and widthwise, although in some embodiments, one or more of the bonds 1303 can be configured to be asymmetrical. In various embodiments, a few, or some, or substantially all, or all of the bonds 1303 in the bond pattern 1302 can be configured with one or more overall bond shapes as described herein, including any of the alternative embodiments. The bonds 1303 uniformly repeat in the secondary direction 1305 to form a row. The secondary row of the bonds 1303 repeats in the primary direction 1304 to form the bond pattern 1302. In the bond pattern 1302, adjacent secondary rows of the bonds 1303 are staggered and reversed with respect to each other. In the bond pattern 1302, adjacent secondary rows are reversed at equal but opposite angles; that is, in terms of bond angle, the reversed bonds are mirrored by the secondary direction 1305.

Each of the bonds 1303 in the bond pattern 1302 has an overall length Bl of 6.22 mm and an overall width Bw of 0.25 mm, resulting in a shape ratio of 0.04. Each of the bonds 1303 in the bond pattern 1302 is oriented at a bond angle Θ of 35 degrees, resulting in an Lx value of 3.57 mm and an Ly value of 5.10 mm. With respect to each other, the bonds 1303 in the bond pattern 1302 have an Sx value of 2.79 mm and an Sy value of 4.00 mm, resulting in a center spacing ratio of 1.43. The bonds 1303 in the bond pattern 1302 also have an SAx value of 2.01 mm or 32%, an SAy value of −1.10 mm or −18%, an SNAx value of −0.79 mm or −13%, and an SNAy value of −2.96 mm or −48%. The bonds 1303 in the bond pattern 1302 further have an SAd value of 0.69 mm and an SNAd value of 0.43 mm, resulting in a perimeter spacing ratio of 1.60. The line of SNAd forms a bisect angle Ω of 55 degrees. The bond pattern 1302 has a bond area of 11%.

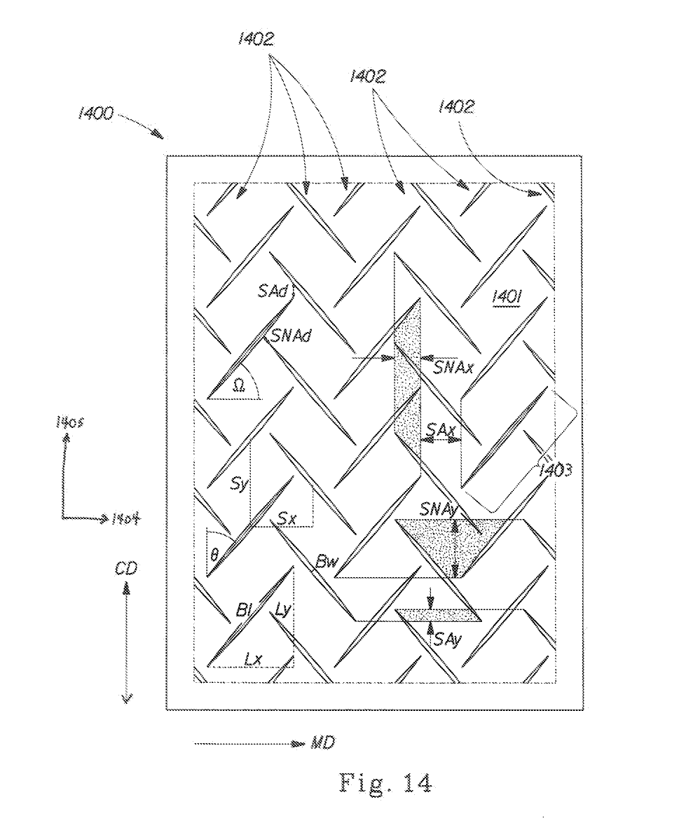

FIG. 14 is a top view of a bonded fibrous web 1400 having a fibrous web 1401 bonded with a fourteenth bond pattern 1402 of bonds 1403. The fibrous web 1401 has a machine direction MD and a cross direction CD.

The fourteenth bond pattern 1402 has a primary direction 1404 and a secondary direction 1405. In the embodiment of FIG. 14, the primary direction 1404 is parallel to the machine direction of the fibrous web 1401 and the secondary direction 1405 is parallel to the cross direction of the fibrous web 1401.

The fibrous web 1401 can be any kind of fibrous web described herein, in any size or shape. The bonds 1403 can be any kind of bond described herein, in any size or shape. The double-dash lines that surround the bond pattern 1402 represent the bond pattern 1402 as having an area of variable length and width within the fibrous web 1401. The bond pattern 1402 can be imparted to the fibrous web 1401 using any kind of process described herein.

Each of the bonds 1403 in the bond pattern 1402 has an overall shape that is relatively long, thin, and curved, tapering to two ends. Each of the bonds 1403 is symmetrical lengthwise and widthwise, although in some embodiments, one or more of the bonds 1403 can be configured to be asymmetrical. In various embodiments, a few, or some, or substantially all, or all of the bonds 1403 in the bond pattern 1402 can be configured with one or more overall bond shapes as described herein, including any of the alternative embodiments. The bonds 1403 uniformly repeat in the secondary direction 1405 to form a row. The secondary row of the bonds 1403 repeats in the primary direction 1404 to form the bond pattern 1402. In the bond pattern 1402, adjacent secondary rows of the bonds 1403 are staggered and reversed with respect to each other. In the bond pattern 1402, adjacent secondary rows are reversed at equal but opposite angles; that is, in terms of bond angle, the reversed bonds are mirrored by the secondary direction 1405.

Each of the bonds 1403 in the bond pattern 1402 has an overall length Bl of 5.97 mm and an overall width Bw of 0.25 mm, resulting in a shape ratio of 0.04. Each of the bonds 1403 in the bond pattern 1402 is oriented at a bond angle Θ of 40 degrees, resulting in an Lx value of 3.84 mm and an Ly value of 4.57 mm. With respect to each other, the bonds 1403 in the bond pattern 1402 have an Sx value of 2.79 mm and an Sy value of 4.00 mm, resulting in a center spacing ratio of 1.43. The bonds 1403 in the bond pattern 1402 also have an SAx value of 1.74 mm or 29%, an SAy value of −0.57 mm or −10%, an SNAx value of −0.97 mm or −16%, and an SNAy value of −2.43 mm or −41%. The bonds 1403 in the bond pattern 1402 further have an SAd value of 0.58 mm and an SNAd value of 0.36 mm, resulting in a perimeter spacing ratio of 1.61. The line of SNAd forms a bisect angle Ω of 50 degrees. The bond pattern 1402 has a bond area of 10%.

FIG. 15 is a top view of a bonded fibrous web 1500 having a fibrous web 1501 bonded with a fifteenth bond pattern 1502 of bonds 1503. The fibrous web 1501 has a machine direction MD and a cross direction CD.

The fifteenth bond pattern 1502 has a primary direction 1504 and a secondary direction 1505. In the embodiment of FIG. 15, the primary direction 1504 is parallel to the machine direction of the fibrous web 1501 and the secondary direction 1505 is parallel to the cross direction of the fibrous web 1501.

The fibrous web 1501 can be any kind of fibrous web described herein, in any size or shape. The bonds 1503 can be any kind of bond described herein, in any size or shape. The double-dash lines that surround the bond pattern 1502 represent the bond pattern 1502 as having an area of variable length and width within the fibrous web 1501. The bond pattern 1502 can be imparted to the fibrous web 1501 using any kind of process described herein.

Each of the bonds 1503 in the bond pattern 1502 has an overall shape that is relatively long, thin, and curved, tapering to two ends. Each of the bonds 1503 is symmetrical lengthwise and widthwise, although in some embodiments, one or more of the bonds 1503 can be configured to be asymmetrical. In various embodiments, a few, or some, or substantially all, or all of the bonds 1503 in the bond pattern 1502 can be configured with one or more overall bond shapes as described herein, including any of the alternative embodiments. The bonds 1503 uniformly repeat in the secondary direction 1505 to form a row. The secondary row of the bonds 1503 repeats in the primary direction 1504 to form the bond pattern 1502. In the bond pattern 1502, adjacent secondary rows of the bonds 1503 are staggered and reversed with respect to each other. In the bond pattern 1502, adjacent secondary rows are reversed at equal but opposite angles; that is, in terms of bond angle, the reversed bonds are mirrored by the secondary direction 1505.

Each of the bonds 1503 in the bond pattern 1502 has an overall length Bl of 5.32 mm and an overall width Bw of 0.25 mm, resulting in a shape ratio of 0.05. Each of the bonds 1503 in the bond pattern 1502 is oriented at a bond angle Θ of 45 degrees, resulting in an Lx value of 3.76 mm and an Ly value of 3.76 mm. With respect to each other, the bonds 1503 in the bond pattern 1502 have an Sx value of 2.79 mm and an Sy value of 4.00 mm, resulting in a center spacing ratio of 1.43. The bonds 1503 in the bond pattern 1502 also have an SAx value of 1.82 mm or 34%, an SAy value of 0.24 mm or 4%, an SNAx value of −0.89 mm or −17%, and an SNAy value of −1.75 mm or −33%. The bonds 1503 in the bond pattern 1502 further have an SAd value of 0.80 mm and an SNAd value of 0.58 mm, resulting in a perimeter spacing ratio of 1.39. The line of SNAd forms a bisect angle Ω of 45 degrees. The bond pattern 1502 has a bond area of 9%.

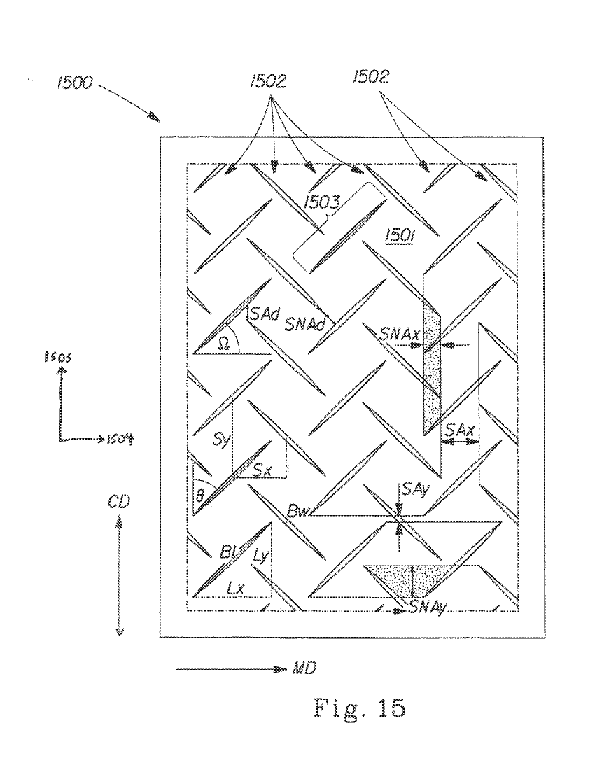

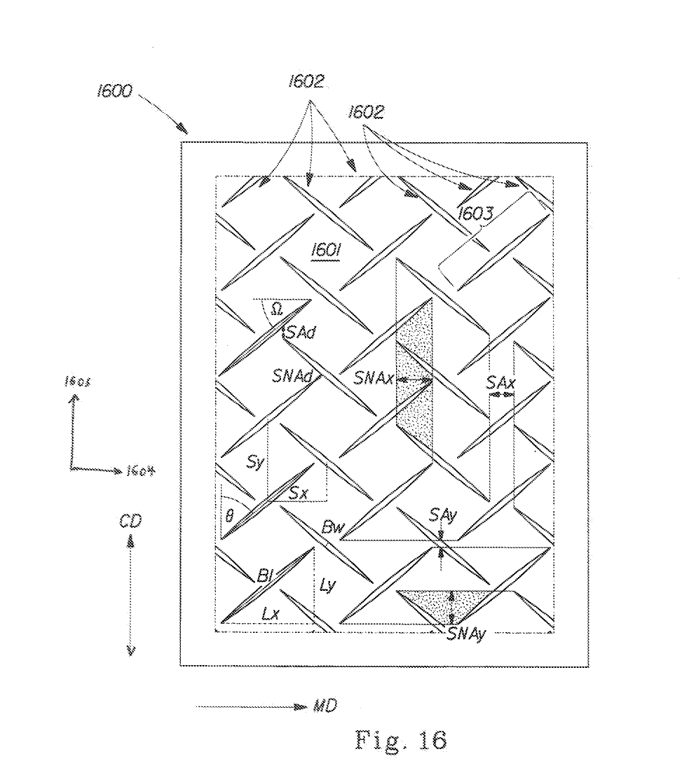

FIG. 16 is a top view of a bonded fibrous web 1600 having a fibrous web 1601 bonded with a sixteenth bond pattern 1602 of bonds 1603. The fibrous web 1601 has a machine direction MD and a cross direction CD.

The sixteenth bond pattern 1602 has a primary direction 1604 and a secondary direction 1605. In the embodiment of FIG. 16, the primary direction 1604 is parallel to the machine direction of the fibrous web 1601 and the secondary direction 1605 is parallel to the cross direction of the fibrous web 1601.

The fibrous web 1601 can be any kind of fibrous web described herein, in any size or shape. The bonds 1603 can be any kind of bond described herein, in any size or shape. The double-dash lines that surround the bond pattern 1602 represent the bond pattern 1602 as having an area of variable length and width within the fibrous web 1601. The bond pattern 1602 can be imparted to the fibrous web 1601 using any kind of process described herein.

Each of the bonds 1603 in the bond pattern 1602 has an overall shape that is relatively long, thin, and curved, tapering to two ends. Each of the bonds 1603 is symmetrical lengthwise and widthwise, although in some embodiments, one or more of the bonds 1603 can be configured to be asymmetrical. In various embodiments, a few, or some, or substantially all, or all of the bonds 1603 in the bond pattern 1602 can be configured with one or more overall bond shapes as described herein, including any of the alternative embodiments. The bonds 1603 uniformly repeat in the secondary direction 1605 to form a row. The secondary row of the bonds 1603 repeats in the primary direction 1604 to form the bond pattern 1602. In the bond pattern 1602, adjacent secondary rows of the bonds 1603 are staggered and reversed with respect to each other. In the bond pattern 1602, adjacent secondary rows are reversed at equal but opposite angles; that is, in terms of bond angle, the reversed bonds are mirrored by the secondary direction 1605.

Each of the bonds 1603 in the bond pattern 1602 has an overall length Bl of 5.75 mm and an overall width Bw of 0.25 mm, resulting in a shape ratio of 0.04. Each of the bonds 1603 in the bond pattern 1602 is oriented at a bond angle Θ of 50 degrees, resulting in an Lx value of 4.40 mm and an Ly value of 3.70 mm. With respect to each other, the bonds 1603 in the bond pattern 1602 have an Sx value of 2.79 mm and an Sy value of 4.00 mm, resulting in a center spacing ratio of 1.43. The bonds 1603 in the bond pattern 1602 also have an SAx value of 1.18 mm or 20%, an SAy value of 0.30 mm or 5%, an SNAx value of −1.51 mm or −26%, and an SNAy value of −1.64 mm or −29%. The bonds 1603 in the bond pattern 1602 further have an SAd value of 0.51 mm and an SNAd value of 0.37 mm, resulting in a perimeter spacing ratio of 1.37. The line of SNAd forms a bisect angle Ω of 40 degrees. The bond pattern 1602 has a bond area of 10%.

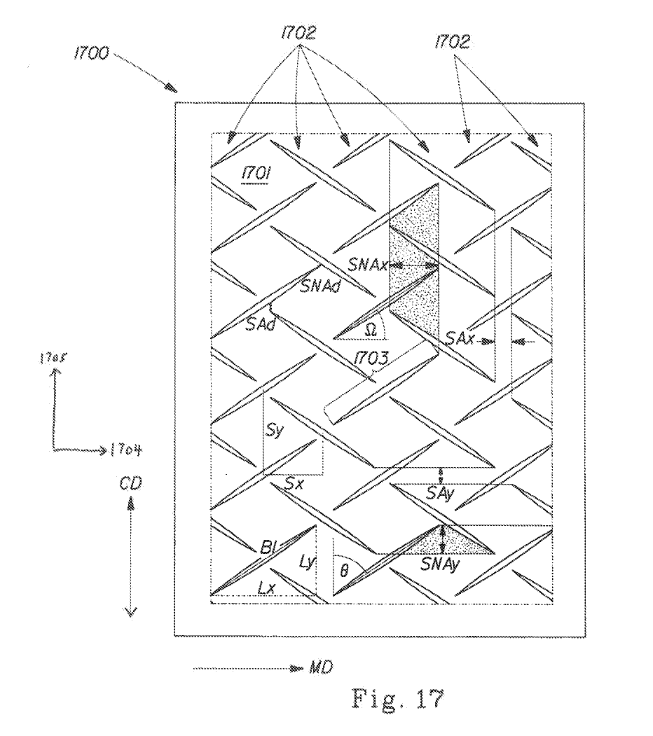

FIG. 17 is a top view of a bonded fibrous web 1700 having a fibrous web 1701 bonded with a seventeenth bond pattern 1702 of bonds 1703. The fibrous web 1701 has a machine direction MD and a cross direction CD.

The seventeenth bond pattern 1702 has a primary direction 1704 and a secondary direction 1705. In the embodiment of FIG. 17, the primary direction 1704 is parallel to the machine direction of the fibrous web 1701 and the secondary direction 1705 is parallel to the cross direction of the fibrous web 1701.

The fibrous web 1701 can be any kind of fibrous web described herein, in any size or shape. The bonds 1703 can be any kind of bond described herein, in any size or shape. The double-dash lines that surround the bond pattern 1702 represent the bond pattern 1702 as having an area of variable length and width within the fibrous web 1701. The bond pattern 1702 can be imparted to the fibrous web 1701 using any kind of process described herein.

Each of the bonds 1703 in the bond pattern 1702 has an overall shape that is relatively long, thin, and curved, tapering to two ends. Each of the bonds 1703 is symmetrical lengthwise and widthwise, although in some embodiments, one or more of the bonds 1703 can be configured to be asymmetrical. In various embodiments, a few, or some, or substantially all, or all of the bonds 1703 in the bond pattern 1702 can be configured with one or more overall bond shapes as described herein, including any of the alternative embodiments. The bonds 1703 uniformly repeat in the secondary direction 1705 to form a row. The secondary row of the bonds 1703 repeats in the primary direction 1704 to form the bond pattern 1702. In the bond pattern 1702, adjacent secondary rows of the bonds 1703 are staggered and reversed with respect to each other. In the bond pattern 1702, adjacent secondary rows are reversed at equal but opposite angles; that is, in terms of bond angle, the reversed bonds are mirrored by the secondary direction 1705.

Each of the bonds 1703 in the bond pattern 1702 has an overall length Bl of 5.88 mm and an overall width Bw of 0.25 mm, resulting in a shape ratio of 0.04. Each of the bonds 1703 in the bond pattern 1702 is oriented at a bond angle Θ of 55 degrees, resulting in an Lx value of 4.82 mm and an Ly value of 3.37 mm. With respect to each other, the bonds 1703 in the bond pattern 1702 have an Sx value of 2.79 mm and an Sy value of 4.00 mm, resulting in a center spacing ratio of 1.43. The bonds 1703 in the bond pattern 1702 also have an SAx value of 0.76 mm or 13%, an SAy value of 0.63 mm or 11%, an SNAx value of −2.02 mm or −34%, and an SNAy value of −1.33 mm or −23%. The bonds 1703 in the bond pattern 1702 further have an SAd value of 0.47 mm and an SNAd value of 0.32 mm, resulting in a perimeter spacing ratio of 1.49. The line of SNAd forms a bisect angle Ω of 35 degrees. The bond pattern 1702 has a bond area of 10%.

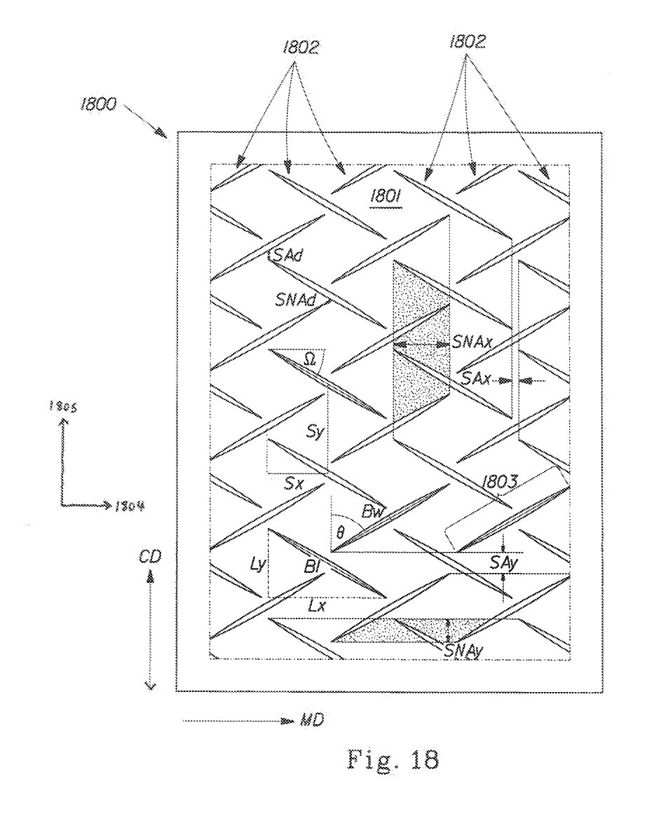

FIG. 18 is a top view of a bonded fibrous web 1800 having a fibrous web 1801 bonded with a eighteenth bond pattern 1802 of bonds 1803. The fibrous web 1801 has a machine direction MD and a cross direction CD.

The eighteenth bond pattern 1802 has a primary direction 1804 and a secondary direction 1805. In the embodiment of FIG. 18, the primary direction 1804 is parallel to the machine direction of the fibrous web 1801 and the secondary direction 1805 is parallel to the cross direction of the fibrous web 1801.

The fibrous web 1801 can be any kind of fibrous web described herein, in any size or shape. The bonds 1803 can be any kind of bond described herein, in any size or shape. The double-dash lines that surround the bond pattern 1802 represent the bond pattern 1802 as having an area of variable length and width within the fibrous web 1801. The bond pattern 1802 can be imparted to the fibrous web 1801 using any kind of process described herein.

Each of the bonds 1803 in the bond pattern 1802 has an overall shape that is relatively long, thin, and curved, tapering to two ends. Each of the bonds 1803 is symmetrical lengthwise and widthwise, although in some embodiments, one or more of the bonds 1803 can be configured to be asymmetrical. In various embodiments, a few, or some, or substantially all, or all of the bonds 1803 in the bond pattern 1802 can be configured with one or more overall bond shapes as described herein, including any of the alternative embodiments. The bonds 1803 uniformly repeat in the secondary direction 1805 to form a row. The secondary row of the bonds 1803 repeats in the primary direction 1804 to form the bond pattern 1802. In the bond pattern 1802, adjacent secondary rows of the bonds 1803 are staggered and reversed with respect to each other. In the bond pattern 1802, adjacent secondary rows are reversed at equal but opposite angles; that is, in terms of bond angle, the reversed bonds are mirrored by the secondary direction 1805.

Each of the bonds 1803 in the bond pattern 1802 has an overall length Bl of 6.13 mm and an overall width Bw of 0.25 mm, resulting in a shape ratio of 0.04. Each of the bonds 1803 in the bond pattern 1802 is oriented at a bond angle Θ of 60 degrees, resulting in an Lx value of 5.31 mm and an Ly value of 3.07 mm. With respect to each other, the bonds 1803 in the bond pattern 1802 have an Sx value of 2.79 mm and an Sy value of 4.00 mm, resulting in a center spacing ratio of 1.43. The bonds 1803 in the bond pattern 1802 also have an SAx value of 0.27 mm or 4%, an SAy value of 0.93 mm or 15%, an SNAx value of −2.51 mm or −41%, and an SNAy value of −0.91 mm or −15%. The bonds 1803 in the bond pattern 1802 further have an SAd value of 0.37 mm and an SNAd value of 0.39 mm, resulting in a perimeter spacing ratio of 0.96. The line of SNAd forms a bisect angle Ω of 30 degrees. The bond pattern 1802 has a bond area of 11%.

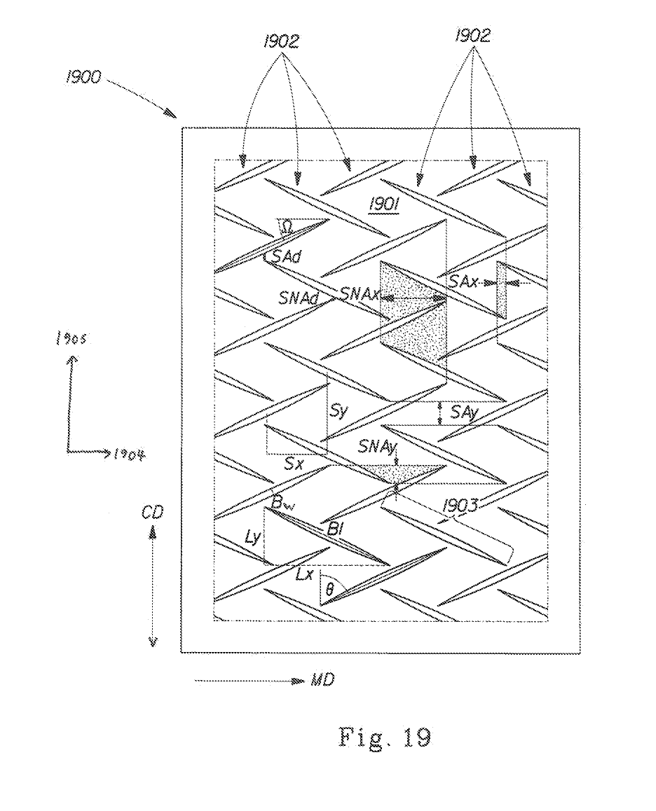

FIG. 19 is a top view of a bonded fibrous web 1900 having a fibrous web 1901 bonded with a nineteenth bond pattern 1902 of bonds 1903. The fibrous web 1901 has a machine direction MD and a cross direction CD.

The nineteenth bond pattern 1902 has a primary direction 1904 and a secondary direction 1905. In the embodiment of FIG. 19, the primary direction 1904 is parallel to the machine direction of the fibrous web 1901 and the secondary direction 1905 is parallel to the cross direction of the fibrous web 1901.

The fibrous web 1901 can be any kind of fibrous web described herein, in any size or shape. The bonds 1903 can be any kind of bond described herein, in any size or shape. The double-dash lines that surround the bond pattern 1902 represent the bond pattern 1902 as having an area of variable length and width within the fibrous web 1901. The bond pattern 1902 can be imparted to the fibrous web 1901 using any kind of process described herein.

Each of the bonds 1903 in the bond pattern 1902 has an overall shape that is relatively long, thin, and curved, tapering to two ends. Each of the bonds 1903 is symmetrical lengthwise and widthwise, although in some embodiments, one or more of the bonds 1903 can be configured to be asymmetrical. In various embodiments, a few, or some, or substantially all, or all of the bonds 1903 in the bond pattern 1902 can be configured with one or more overall bond shapes as described herein, including any of the alternative embodiments. The bonds 1903 uniformly repeat in the secondary direction 1905 to form a row. The secondary row of the bonds 1903 repeats in the primary direction 1904 to form the bond pattern 1902. In the bond pattern 1902, adjacent secondary rows of the bonds 1903 are staggered and reversed with respect to each other. In the bond pattern 1902, adjacent secondary rows are reversed at equal but opposite angles; that is, in terms of bond angle, the reversed bonds are mirrored by the secondary direction 1905.

Each of the bonds 1903 in the bond pattern 1902 has an overall length Bl of 6.67 mm and an overall width Bw of 0.25 mm, resulting in a shape ratio of 0.04. Each of the bonds 1903 in the bond pattern 1902 is oriented at a bond angle Θ of 65 degrees, resulting in an Lx value of 6.05 mm and an Ly value of 2.82 mm. With respect to each other, the bonds 1903 in the bond pattern 1902 have an Sx value of 2.79 mm and an Sy value of 4.00 mm, resulting in a center spacing ratio of 1.43. The bonds 1903 in the bond pattern 1902 also have an SAx value of −0.47 mm or −7%, an SAy value of 1.18 mm or 18%, an SNAx value of −3.19 mm or −48%, and an SNAy value of −0.73 mm or −11%. The bonds 1903 in the bond pattern 1902 further have an SAd value of 0.34 mm and an SNAd value of 0.40 mm, resulting in a perimeter spacing ratio of 0.84. The line of SNAd forms a bisect angle Ω of 25 degrees. The bond pattern 1902 has a bond area of 13%.

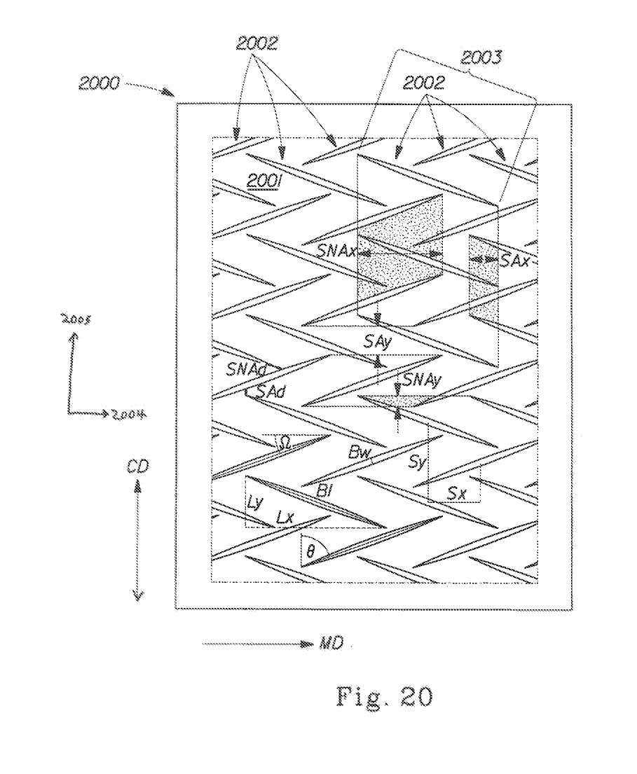

FIG. 20 is a top view of a bonded fibrous web 2000 having a fibrous web 2001 bonded with a twentieth bond pattern 2002 of bonds 2003. The fibrous web 2001 has a machine direction MD and a cross direction CD.

The twentieth bond pattern 2002 has a primary direction 2004 and a secondary direction 2005. In the embodiment of FIG. 20, the primary direction 2004 is parallel to the machine direction of the fibrous web 2001 and the secondary direction 2005 is parallel to the cross direction of the fibrous web 2001.

The fibrous web 2001 can be any kind of fibrous web described herein, in any size or shape. The bonds 2003 can be any kind of bond described herein, in any size or shape. The double-dash lines that surround the bond pattern 2002 represent the bond pattern 2002 as having an area of variable length and width within the fibrous web 2001. The bond pattern 2002 can be imparted to the fibrous web 2001 using any kind of process described herein.

Each of the bonds 2003 in the bond pattern 2002 has an overall shape that is relatively long, thin, and curved, tapering to two ends. Each of the bonds 2003 is symmetrical lengthwise and widthwise, although in some embodiments, one or more of the bonds 2003 can be configured to be asymmetrical. In various embodiments, a few, or some, or substantially all, or all of the bonds 2003 in the bond pattern 2002 can be configured with one or more overall bond shapes as described herein, including any of the alternative embodiments. The bonds 2003 uniformly repeat in the secondary direction 2005 to form a row. The secondary row of the bonds 2003 repeats in the primary direction 2004 to form the bond pattern 2002. In the bond pattern 2002, adjacent secondary rows of the bonds 2003 are staggered and reversed with respect to each other. In the bond pattern 2002, adjacent secondary rows are reversed at equal but opposite angles; that is, in terms of bond angle, the reversed bonds are mirrored by the secondary direction 2005.

Each of the bonds 2003 in the bond pattern 2002 has an overall length Bl of 7.52 mm and an overall width Bw of 0.25 mm, resulting in a shape ratio of 0.03. Each of the bonds 2003 in the bond pattern 2002 is oriented at a bond angle Θ of 70 degrees, resulting in an Lx value of 7.07 mm and an Ly value of 2.57 mm. With respect to each other, the bonds 2003 in the bond pattern 2002 have an Sx value of 2.79 mm and an Sy value of 4.00 mm, resulting in a center spacing ratio of 1.43. The bonds 2003 in the bond pattern 2002 also have an SAx value of −1.49 mm or −20%, an SAy value of 1.43 mm or 19%, an SNAx value of −4.20 mm or −56%, and an SNAy value of −0.52 mm or −7%. The bonds 2003 in the bond pattern 2002 further have an SAd value of 0.31 mm and an SNAd value of 0.43 mm, resulting in a perimeter spacing ratio of 0.72. The line of SNAd forms a bisect angle Ω of 20 degrees. The bond pattern 2002 has a bond area of 15%.

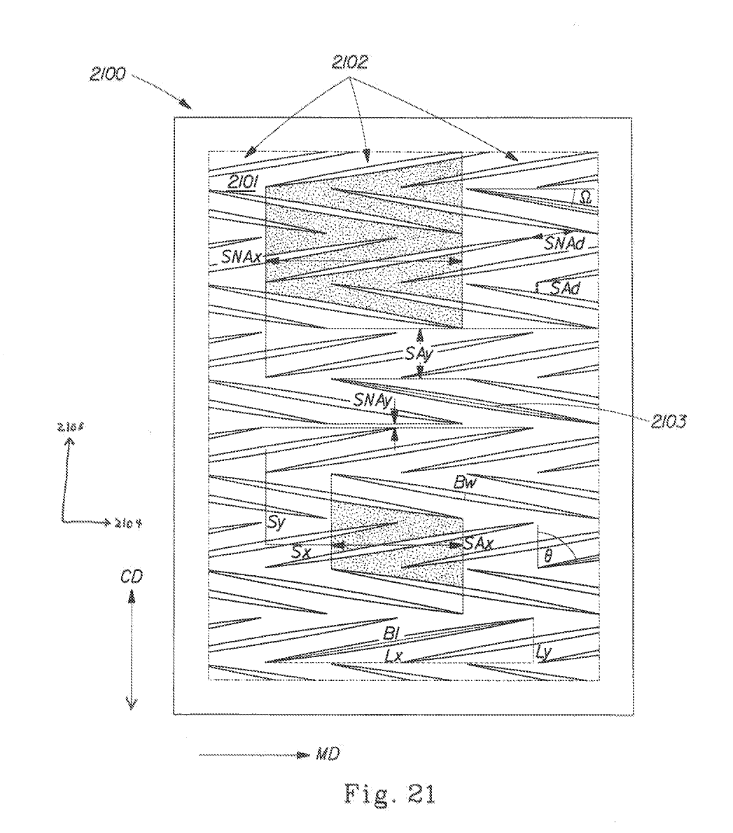

FIG. 21 is a top view of a bonded fibrous web 2100 having a fibrous web 2101 bonded with a twenty-first bond pattern 2102 of bonds 2103. The fibrous web 2101 has a machine direction MD and a cross direction CD.

The twenty-first bond pattern 2102 has a primary direction 2104 and a secondary direction 2105. In the embodiment of FIG. 21, the primary direction 2104 is parallel to the machine direction of the fibrous web 2101 and the secondary direction 2105 is parallel to the cross direction of the fibrous web 2101.

The fibrous web 2101 can be any kind of fibrous web described herein, in any size or shape. The bonds 2103 can be any kind of bond described herein, in any size or shape. The double-dash lines that surround the bond pattern 2102 represent the bond pattern 2102 as having an area of variable length and width within the fibrous web 2101. The bond pattern 2102 can be imparted to the fibrous web 2101 using any kind of process described herein.

Each of the bonds 2103 in the bond pattern 2102 has an overall shape that is relatively long, thin, and curved, tapering to two ends. Each of the bonds 2103 is symmetrical lengthwise and widthwise, although in some embodiments, one or more of the bonds 2103 can be configured to be asymmetrical. In various embodiments, a few, or some, or substantially all, or all of the bonds 2103 in the bond pattern 2102 can be configured with one or more overall bond shapes as described herein, including any of the alternative embodiments. The bonds 2103 uniformly repeat in the secondary direction 2105 to form a row. The secondary row of the bonds 2103 repeats in the primary direction 2104 to form the bond pattern 2102. In the bond pattern 2102, adjacent secondary rows of the bonds 2103 are staggered and reversed with respect to each other. In the bond pattern 2102, adjacent secondary rows are reversed at equal but opposite angles; that is, in terms of bond angle, the reversed bonds are mirrored by the secondary direction 2105.

Each of the bonds 2103 in the bond pattern 2102 has an overall length Bl of 11.17 mm and an overall width Bw of 0.25 mm, resulting in a shape ratio of 0.02. Each of the bonds 2103 in the bond pattern 2102 is oriented at a bond angle Θ of 80 degrees, resulting in an Lx value of 11.00 mm and an Ly value of 1.94 mm. With respect to each other, the bonds 2103 in the bond pattern 2102 have an Sx value of 2.79 mm and an Sy value of 4.00 mm, resulting in a center spacing ratio of 1.43. The bonds 2103 in the bond pattern 2102 also have an SAx value of −5.42 mm or −49%, an SAy value of 2.06 mm or 18%, an SNAx value of −8.53 mm or −76%, and an SNAy value of 0.07 mm or 1%. The bonds 2103 in the bond pattern 2102 further have an SAd value of 0.42 mm and an SNAd value of 1.14 mm, resulting in a perimeter spacing ratio of 0.37. The line of SNAd forms a bisect angle Ω of 10 degrees. The bond pattern 2102 has a bond area of 20%.

It is contemplated that any of the embodiments of FIGS. 1-5 and 7-21 can be varied in a number of alternate ways, as described below. First, in various embodiments, the bonds in the bond pattern can be oriented at a bond angle of 25, 30, 31, 32, 33, 34, 35, 40, 45, 50, 55, or 60 degrees, or any integer value between any of these values, or within any range defined by any of these values. Second, in some embodiments, the geometry of the bond pattern can be varied to obtain an SNAx value that is <−10%, <−9%, <−8%, <−7%, <−6%, <−5%, <−4.5%, <−4%, <−3.5%, <−3%, <−2.5%, <−2%, <−1.5%, <−1%, or any value between any of these values, or within any range defined by any of these values. Third, in some embodiments, the geometry of the bond pattern can be varied to obtain an SNAy value that is <−10%, <−9%, <−8%, <−7%, <−6%, <−5%, <−4.5%, <−4%, <−3.5%, <−3%, <−2.5%, <−2%, <−1.5%, <−1%, or any value between any of these values, or within any range defined by any of these values. These first, second, and third alternate embodiments, as described above, can be applied independently or in any combination together, in any workable fashion.

It is also contemplated that the dimensions and geometric properties of any of the embodiments of FIGS. 1-5 and 7-21 can also be varied within various ranges, as described below. The bonds in the bond pattern can be varied to obtain a shape ratio of 0.03, 0.04, 0.05, 0.06, 0.07, 0.08, 0.10, 0.15, 0.20, 0.25, 0.30, 0.35, or 0.40 or any value in increments of 0.01 between any of these values, or within any range defined by any of these values, resulting in various values for Bw and Bl, various bond angles, various values for Lx and Ly, and various bond areas. The geometry of the bond pattern can be varied to increase or decrease SAx, SAy, SNAx, SNAy, SAd, and/or SNAd by 5%, 10%, 15%, 20%, 25%, 30%, 35%, or 40%, or any integer value between any of these values, or within any range defined by any of these values, in any workable combination, resulting in various percentage values, various center spacing ratios, various perimeter spacing ratios, and various bond areas. Each of these dimensions and geometric properties described above can be varied independently, or in any combination together, or in any combination with any of the alternate embodiments described herein, in any workable fashion.

It is further contemplated that any of the embodiments of FIGS. 1-5 and 7-21 can be varied by orienting the bond pattern at an angle with respect to the fibrous web in which it is included. In the embodiments described and illustrated herein, the primary and secondary directions of the bond patterns are aligned with the machine and cross directions of the fibrous web. However, this is not required. In various embodiments, the primary and secondary directions of any of the bond patterns described herein can be oriented, with respect to the machine and cross directions of the fibrous web, at any integer angle between 0° and 360° or within any range defined by any of these values, resulting in various angled bond patterns.

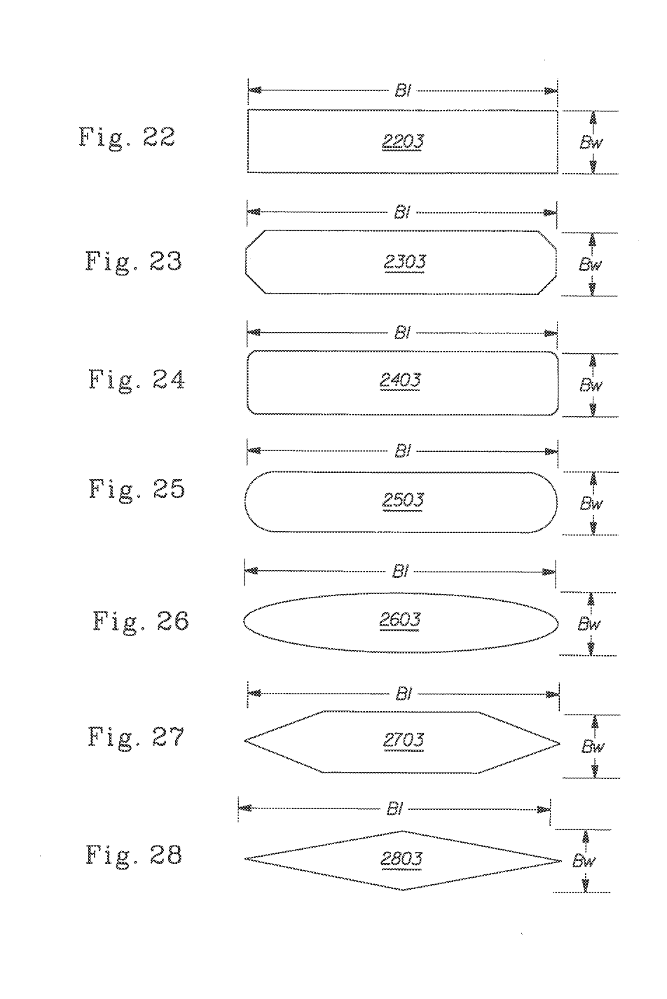

FIGS. 22-28 illustrate exemplary embodiments for overall shapes of an individual bond. In each of FIGS. 22-28, the overall length of the bond Bl and the overall width of a bond Bw are provided for reference.

FIG. 22 is a top view of an exemplary bond 2203 with an overall shape that is rectangular. FIG. 23 is a top view of an exemplary bond 2303 with an overall shape that is rectangular with squared off corners. The overall shape of bond 2303 can also be understood as octagonal. FIG. 24 is a top view of an exemplary bond 2403 with an overall shape that is rectangular with rounded corners. FIG. 25 is a top view of an exemplary bond 2503 with an overall shape that is substantially rectangular with semicircular ends. FIG. 26 is a top view of an exemplary bond 2603 with an overall shape that is oval. FIG. 27 is a top view of an exemplary bond 2703 with an overall shape that is hexagonal. FIG. 28 is a top view of an exemplary bond 2803 with an overall shape that is diamond shaped.

In various alternative embodiments, a bond can have an overall shape that is a variation of any of the shapes illustrated in the embodiments of FIGS. 22-28, or a combination of any of the shapes illustrated in the embodiments of FIGS. 22-28. Also, a bond can have an overall shape that is straight, curved, angled, or any regular or irregular geometric shape (such as a square, triangle, trapezoid, pentagon, star, half circle, a quarter circle, a half oval, a quarter oval, etc.), a recognizable image (such as a letter, number, word, character, face of an animal, face of a person, etc.), or another recognizable image (such as a plant, a car, etc.), another shape, or combinations of any of the shapes described above.

Fibrous webs having one or more bond patterns of the present disclosure, can also be used in various other articles, including wipes, diaper wipes, body wipes, toilet tissue, facial tissue, dryer sheets, wound dressings, handkerchiefs, household wipes, window wipes, bathroom wipes, surface wipes, countertop wipes, floor wipes, and other articles, as will be understood by one of skill in the art. The present disclosure also contemplates that any of the bond patterns disclosed herein can be used with other materials such as films and laminates.

The embodiments described herein are bonded fibrous webs having various bond patterns with relatively low bond areas, wherein each of the bonded fibrous webs still has a relatively high tensile strength and a relatively high neckdown modulus. These parameters can be understood and appreciated by comparing the bonded fibrous webs described herein to a reference material. The bonded fibrous webs described herein have various bond patterns. The reference material is a bonded fibrous web that has a particular, commonly used bond pattern, referred to herein as the reference bond pattern.

FIG. 29 is a top view of a bonded fibrous web 2900, which is the reference material. The bonded fibrous web 2900 has a fibrous web 2901. The fibrous web 2901 has a machine direction MD and a cross direction CD.

The fibrous web 2901 has three layers of spunbonded fibers, which form an SSS type material. In the fibrous web 2901, each of the fibers is a bicomponent fiber made from 30% polyethylene and 70% polypropylene. As examples, the polyethylene can be a polyethylene such as ASPUN 6834 from Dow Chemical Company of Midland, Mich., United States of America, and the polypropylene can be a polypropylene such as ACHIEVE 1605 from Exxon Mobil of Irving, Tex., United States of America. Each bicomponent fiber is in a sheath/core configuration, with the polyethylene in the sheath and the polypropylene in the core. Each bicomponent fiber has a diameter of 20 microns. A single fiber of the fibrous web 2901 has the following properties: Poisson ratio of 0.3, Modulus of Elasticity of 9.16×10⁸ Pascals, an Engineering Yield Strain of 0.04, and an Engineering Break Strain of 3.39. Each of the three layers has a basis weight of 6 grams per square meter, so the fibrous web 2901 has a basis weight of 18 grams per square meter. The fibrous web 2901 has a machine direction to cross direction laydown ratio between 3 and 4. The fibrous web 2901 can be made on a REICOFIL 3 line from Reifenhauser REICOFIL GmbH & Co. KG, Troisdorf, Germany with the line set up in an SSS type configuration. While the reference material is described above with particular properties, for clarity, it is contemplated that the embodiments of the present disclosure can also be used to obtain desirable properties with fibrous webs configured in various other ways.

The bonded fibrous web 2900 is bonded with the reference bond pattern 2902. The reference bond pattern 2902 is formed by bonds 2903. The reference bond pattern 2902 has a primary direction 2904 and a secondary direction 2905. In the embodiment of FIG. 29, the primary direction 2904 is parallel to the machine direction of the fibrous web 2901 and the secondary direction 2905 is parallel to the cross direction of the fibrous web 2901. The reference bond pattern 2902 can be imparted to the fibrous web 2901.

Each of the bonds 2903 in the reference bond pattern 2902 has an overall shape that is similar to an elongated oval, with two ends. Each of the bonds 2903 is symmetrical lengthwise and widthwise. The bonds 2903 uniformly repeat in the secondary direction 2905 to form a row. The secondary row of the bonds 2903 repeats in the primary direction 2904 to form the reference bond pattern 2902. In the reference bond pattern 2902, adjacent secondary rows of the bonds 2903 are staggered and reversed with respect to each other. In the bond pattern 2902, adjacent secondary rows are reversed at equal but opposite angles; that is, in terms of bond angle, the reversed bonds are mirrored by the secondary direction 2905.

Each of the bonds 2903 in the bond pattern 2902 has an overall length Bl of 0.88 mm and an overall width Bw of 0.52 mm, resulting in a shape ratio of 0.59. Each of the bonds 2903 in the bond pattern 2902 is oriented at a bond angle Θ of 30 degrees, resulting in an Lx value of 0.63 mm and an Ly value of 0.76 mm. With respect to each other, the bonds 2903 in the bond pattern 2902 have an Sx value of 0.76 mm and an Sy value of 2.63 mm, resulting in a center spacing ratio of 3.46. The bonds 2903 in the bond pattern 2902 also have an SAx value of 0.90 mm or 102%, an SAy value of 1.87 mm or 212%, an SNAx value of 0.11 mm or 12%, and an SNAy value of 0.48 mm or 55%. The bonds 2903 in the bond pattern 2902 further have an SAd value of 1.87 mm and an SNAd value of 0.76 mm, resulting in a perimeter spacing ratio of 2.45. The line of SNAd forms a bisect angle Ω of 53 degrees. The bond pattern 2902 has a bond area of 18%. The bonds 2903 of the bonded fibrous web 290 can be created with a thermal calendaring system heated to a temperature of 132-134° C.

Each of the embodiments described herein can be compared to the bonded fibrous web 2900, which is the reference material. Table 1, shown below, describes how each of the bonded fibrous webs 100-2100 is expected to compare with the reference material, for various material properties. For the comparison in Table 1, each of the fibrous webs 101-2101 disclosed herein is made in the same way as the reference material, fibrous web 2901; in particular, each of the fibrous webs is made under the same spinning conditions, with the same laydown, creating fibers of the same size, shape, and mechanical properties, and resulting in equivalent fibrous webs. In addition, for the comparison in Table 1, each of the bonded fibrous webs 100-2100 disclosed herein is bonded in the same way as the reference material, bonded fibrous web 2900, that is, each bond pattern is bonded with individually determined optimal bonding conditions, determined from an optimized bonding curve for cross direction tensile strength, as will be understood by one of ordinary skill in the art.

For each bonded fibrous webs, the value in the column labeled Relative Difference in Bond Area is equal to the bond area of that bonded fibrous web minus the bond area of the reference material, with the result divided by the bond area of the reference material. A bonded fibrous web with a negative value for Relative Difference in Bond Area has relatively less bond area than the reference material. A bonded fibrous web with a positive value for Relative Difference in Bond Area has relatively more bond area than the reference material. It is expected that these results for bond area can be realized for bonded fibrous webs produced with commercial scale equipment under production conditions. It is also expected that embodiments of bonded fibrous webs with negative values for Relative Difference in Bond Area would exhibit improved performance for these properties, relative to the reference material.

Since bonded fibrous webs with relatively lower bond areas typically exhibit better flexibility, pliability, extensibility, softness, fluid-handling, and caliper, it is expected that the embodiments of bonded fibrous webs with negative values for Relative Difference in Bond Area would exhibit improved performance for these properties, relative to the reference material.

For each bonded fibrous web, the value in the column labeled Relative Difference in CD Tensile Strength at Peak Force is equal to the expected cross direction tensile strength at peak force for that bonded fibrous web minus the expected cross direction tensile strength at peak force of the reference material, with the result divided by the expected cross direction tensile strength at peak force of the reference material. A bonded fibrous web with a negative value for Relative CD Tensile Strength at Peak Force has a relatively lower expected cross direction tensile strength at peak force than the reference material. A bonded fibrous web with a positive value for Relative CD Tensile Strength at Peak Force has a relatively higher expected cross direction tensile strength at peak force than the reference material. It is expected that these results for CD tensile strength can be realized for bonded fibrous webs produced with commercial scale equipment under production conditions. Since bonded fibrous webs with relatively higher cross directional tensile strengths typically exhibit better toughness and tear resistance, it is expected that the embodiments of bonded fibrous webs with positive values for Relative Difference in CD Tensile Strength at Peak Force would exhibit improved performance for these properties, relative to the reference material.

For each bonded fibrous web, the value in the column labeled Relative Difference in Neckdown Modulus is equal to the expected neckdown modulus for that bonded fibrous web minus the expected neckdown modulus of the reference material, with the result divided by the expected neckdown modulus of the reference material. A bonded fibrous web with a negative value for Relative Difference in Neckdown Modulus has a relatively lower expected neckdown modulus than the reference material. A bonded fibrous web with a positive value for Relative Difference in Neckdown Modulus has a relatively higher expected neckdown modulus than the reference material. It is expected that these results for neckdown modulus can be realized for bonded fibrous webs produced with commercial scale equipment under production conditions. Since bonded fibrous webs with relatively higher neckdown moduli typically exhibit better toughness and tear resistance, it is expected that the embodiments of bonded fibrous webs with positive values for Relative Difference in Neckdown Modulus would exhibit improved performance for these properties, relative to the reference material.

TABLE 1

| Bonded | Relative | Relative Difference in | Relative |
|---|---|---|---|
| Fibrous | Difference | CD Tensile Strength | Difference in |
| Web | in Bond Area | at Peak Force | Neckdown Modulus |
| 100 | −50% | +11% | +18% |
| 200 | −44% | +28% | +31% |
| 300 | −50% | +1% | +43% |
| 400 | −44% | +59% | +107% |
| 500 | −56% | −2% | −5% |
| 700 | −10% | +46% | +99% |
| 800 | 91% | +54% | +153% |
| 900 | +200% | (no value) | +294% |
| 1000 | +2% | −27% | (no value) |
| 1100 | −19% | +70% | (no value) |
| 1200 | −28% | +102% | +243% |
| 1300 | −38% | +81% | +113% |
| 1400 | −43% | +57% | +303% |
| 1500 | −49% | +27% | +86% |
| 1600 | −42% | +32% | +75% |
| 1700 | −41% | +22% | >+1000% |
| 1800 | −40% | +8% | >+1000% |
| 1900 | −34% | +7% | >+1000% |
| 2000 | −24% | +15% | +445% |
| 2100 | +11% | −15% | (no value) |

### Test Methods

### CD Tensile Strength Test Method

Cross direction tensile strength can be determined by using EDANA 20.2-89, with a sample width of 50 mm and a gage length of 100 mm, using a preload of 0.1 Newtons and a test speed of 100 mm/min, as will be understood by one of ordinary skill in the art. In particular, this test method can be used to determine cross direction tensile strength at peak force.

### Neckdown Modulus Test Method

Neckdown modulus can be determined through various methods, as will be understood by one of ordinary skill in the art. That is to say, there is more than one measurement method that can lead to accurate and consistent results. The following presents one method for determining neckdown modulus in a bonded web of the present disclosure. This method for determining neckdown modulus is described and illustrated in connection with the embodiments of FIGS. 30-34.

First, obtain the following supplies and test equipment: a linear scale that is calibrated in SI units; single-side adhesive tape (such as a SCOTCH #234 General Purpose Masking Tape available from 3M, Saint Paul, Minn., United States of America) that is 50-55 mm wide; a smooth, flat, non-sticky, clean, dry, unobstructed, stationary, horizontal testing surface (such as a large table-top) that is at least 400 mm wide and at least 2 m long; a calibrated tensile force gage with a measuring hook and a capacity of at least 25 Newtons (such as a Medio-Line 40025 available from PESOLA AG, Baar, Switzerland); and a tensioning apparatus.

FIG. 30 illustrates a top view of the tensioning apparatus 3020 for this method of determining neckdown modulus. The tensioning apparatus 3020 is made of a dowel 3021 and a string 3026. The dowel 3021 is a rigid, smooth, straight, round dowel (such as a smooth solid hardwood round dowel with a diameter of 25-30 mm) that has an overall length 3023 of 50 cm measured from its one end 3024 to its other end 3025. The string 3026 is a continuous section of flexible, non-sticky, inelastic string. The string 3026 has a breaking strength of at least 25 Newtons. The string 3026 is 75 cm long and has a diameter that fits into the opening of the measuring hook of the force gage used in this method. Each of the ends 3027, 3028 of the string 3026 is secured to an end of the dowel 3021. Each end of the string 3026 is secured well enough to withstand at least 25 Newtons of force without breaking away from the end of the dowel 3021.

Second, obtain and prepare the test sample, using the supplies and test equipment described above. The test sample must be a continuous portion of a bonded fibrous web. The test sample must be undamaged, undeformed, clean, and dry. The test sample must have a uniform overall width that is between 275 and 325 mm (in the cross direction) and a uniform overall length that is between 1.8 and 2.0 meters (in the machine direction). When laid out flat, the overall length and the overall width of the test sample define a rectangular area. The test sample must have a substantially uniform composition over its entire area. The test sample must have a thickness of 10 mm or less. This test method is not suitable for materials outside of the parameters described above. For at least 24 hours before testing, the test sample must be conditioned at 23° C. and a relative humidity of about 50%. For at least 30 minutes before testing, the test sample must lay flat and under no tension.

FIG. 31 illustrates a top view of an exemplary test sample 3130 for determining neckdown modulus. The test sample has a machine direction MD and a cross direction CD. The test sample 3130 has two side edges 3131, each of which is parallel with the machine direction MD. The test sample 3130 also has two end edges 3132, each of which is perpendicular to the machine direction MD. The test sample 3130 has an overall width 3133, measured in the cross direction CD from one side edge 3131 to the other side edge 3131. The test sample 3130 also has an overall length 3134, measured in the machine direction MD from one end edge 3132 to the other end edge 3132.

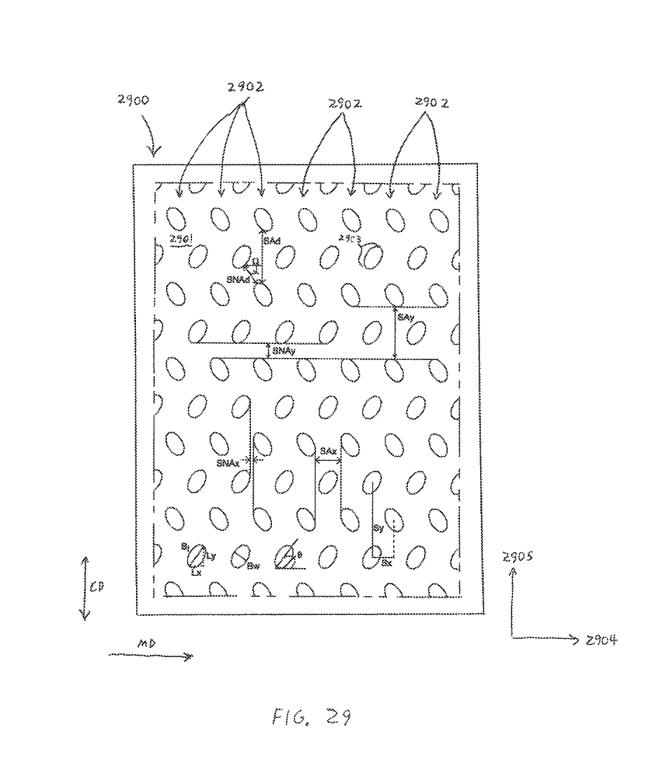

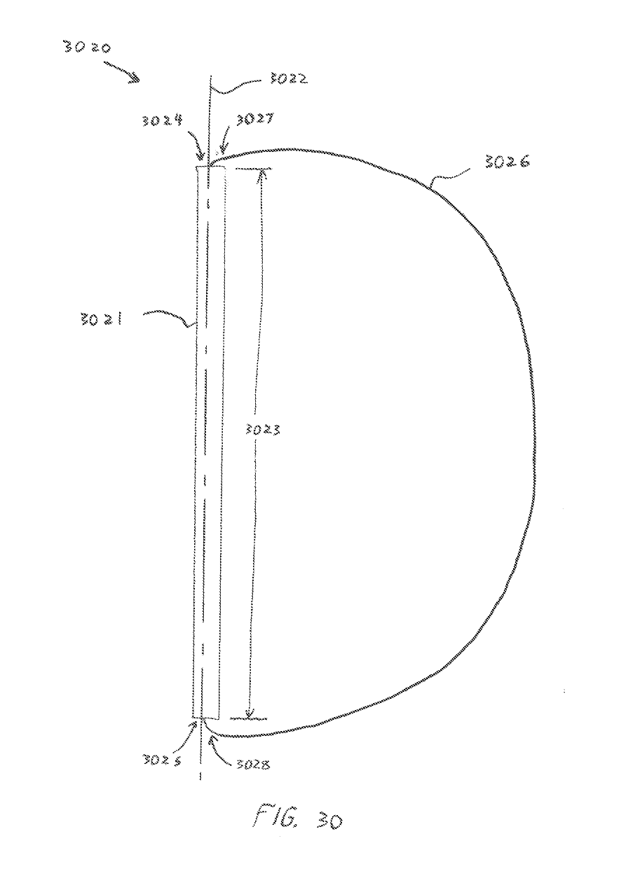

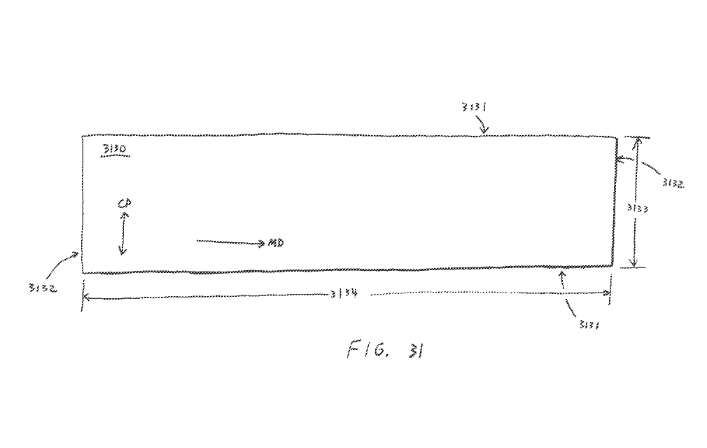

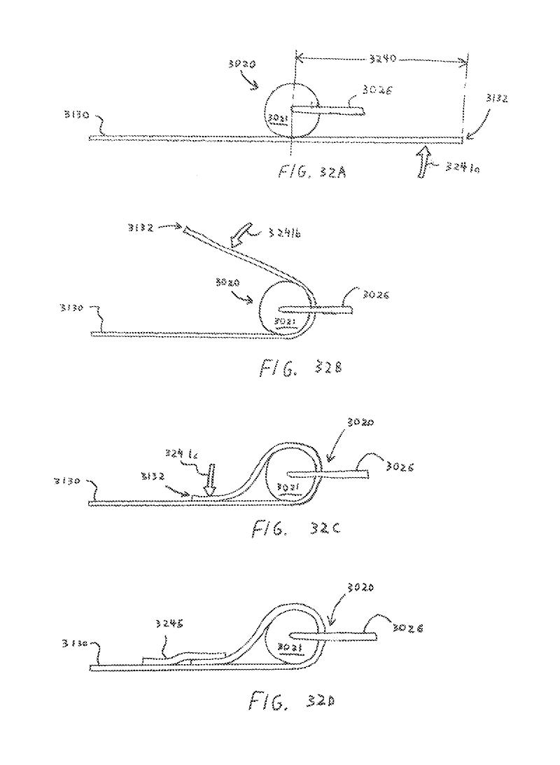

Secure the tensioning apparatus 3020 to the test sample 3130, as illustrated in FIGS. 32A-32D. For clarity, in FIGS. 32A-32D the test sample 3130 and the string 3026 are only shown in relevant part, and the underlying testing surface is not shown. As illustrated in FIG. 32A, lay the test sample 3130 flat on the testing surface. Lay the tensioning apparatus 3020 on top of the test sample 3130, near one of its end edges 3132. The central axis of the dowel 3021 of the tensioning apparatus 3020 must be parallel with the cross direction CD of the test sample. The central axis of the dowel 3021 must be positioned 10 cm inboard from the end edge 3132. Both ends 3024, 3025 of the dowel 3021 must lie outboard from the side edges 3131 of the test sample 3130, as illustrated in FIG. 33. The overall length 3023 of the dowel 3021 should be centered on the overall width 3133 of the test sample 3130.

While holding the dowel 3021 in the position described above, fold up 3241a the nearby end edge 3132 of the test sample 3130 as illustrated in FIG. 32A, wrap 3241b the end edge 3132 of the test sample 3130 around the exposed surface of the dowel 3021 as illustrated in FIG. 32B, and bring down 3241c the end edge 3132 to contact the portion of the test sample 3130 that is inboard to the dowel 3021. The operation described and illustrated in connection with FIGS. 32A-32C is performed uniformly across the overall width 3133 of the test sample 3130.

While the end edge 3132 is held down as illustrated in FIG. 32C, a length of the adhesive tape 3245 is adhered to the test sample 3130, as illustrated in FIG. 32D such that the end edge 3132 is secured in place to the portion of the test sample 3130 that is inboard to the dowel 3021. The width of the adhesive tape 3245 is centered on the end edge 3132 and the adhesive tape 3245 extends across the overall width 3133 of the test sample 3130. The ends of the adhesive tape 3245 are shortened to coincide with the side edges 3131 of the test sample 3130.

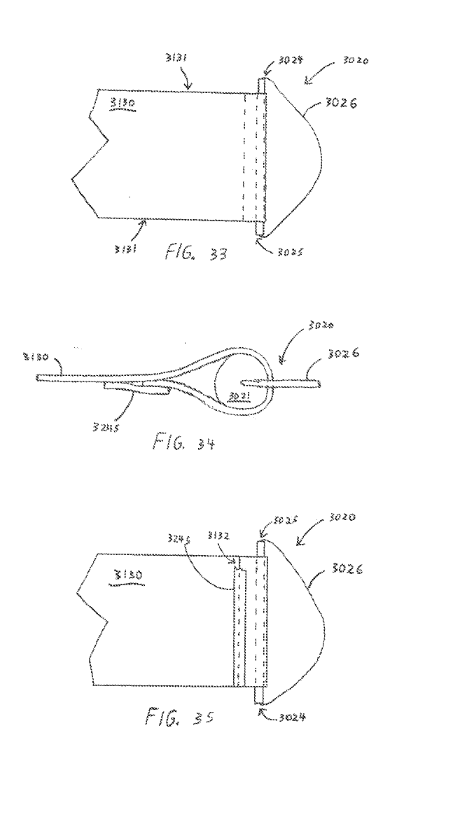

FIGS. 33-35 illustrate the test sample 3130 prepared as described above. FIG. 33 illustrates a top view of the tensioning apparatus 3020 secured to the test sample 3130. FIG. 34 illustrates an enlarged side view of the tensioning apparatus 3020 secured to the test sample 3130. FIG. 35 illustrates a bottom view of the tensioning apparatus 3020 secured to the test sample 3130, with a portion of the adhesive tape 3245 shown as broken away, to illustrate the position of the end edge 3132.

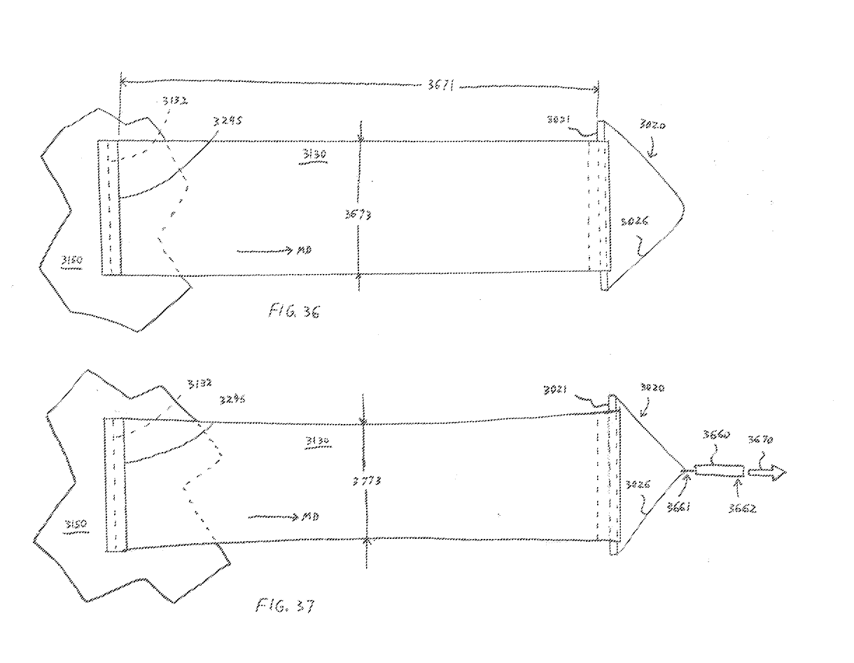

Lay the prepared test sample 3130 flat on top of the testing surface, so that the testing surface fully supports all of the test sample 3130. Secure the test sample 3130 to the testing surface 3150, (shown in part) as illustrated in FIG. 36. To secure the test sample 3130 to the testing surface, hold down the end edge 3132 that is opposite from the end edge 3132 that is secured to the tensioning apparatus 3020. While this end edge 3132 is held down, a length of the adhesive tape 3245 is adhered to the test sample 3130 and to the testing surface 3150, as illustrated in FIG. 32D such that the end edge 3132 is secured to the testing surface 3150. The width of the adhesive tape 3245 is centered on the end edge 3132 and the adhesive tape 3245 extends across the overall width 3133 of the test sample 3130.

After the test sample 3130 is secured to the testing surface 3150, but before the test sample is tensioned, take the following measurements. Measure the effective overall length 3671 of the test sample 3130, which is the distance measured linearly in the machine direction MD, between the inboard edge of the adhesive tape 3245 that is securing the test sample 3130 to the testing surface 3150, and the inboard edge of the dowel 3021 of the tensioning apparatus 3020. Record the measurement for the effective overall length 3671. Also, measure the overall starting width 3673 of the test sample 3130 at the midpoint of the effective overall length; that is, halfway between the inboard edge of the adhesive tape 3245 that is securing the test sample 3130 to the testing surface 3150, and the inboard edge of the dowel 3021 of the tensioning apparatus 3020. Record the measurement for the overall starting width 3673 as width in millimeters at zero Newtons of force.

Third, conduct the testing. The test must be performed at 23° C. with a relative humidity of about 50%. The testing is conducted with the prepared test sample 3130 laying on the testing surface 3150. Substantially all of the test sample 3130 should lay flat on the testing surface 3150, with no overlapping material, gathers, or large wrinkles. Due to the diameter of the dowel 3021, the portion of the test sample 3130 that is immediately inboard to the tensioning apparatus 3020 will not lay flat on the testing surface 3150. However, the portion of the test sample 3130 that wraps around the dowel 3021 should lay on the testing surface 3150. The tensioning apparatus 3020 should be positioned on the testing surface 3150 so that, from the top view, the overall length and the overall width of the test sample 3130 define a rectangular area, as illustrated in FIG. 36.

With the test sample 3130 laying on the testing surface 3150, as described above, attach the measuring hook 3661 of the force gage 3660 to the middle of the string 3026 of the tensioning apparatus 3020. With the test sample 3130 still laying on the testing surface 3150, apply tension to the test sample 3150 and record measurements as described below. To apply tension to the test sample 3150, slowly pull 3670 on the fixed end 3662 of the force gage 3660. Pull 3670 on the fixed end 3662 in a direction that is parallel to the testing surface 3150 and parallel to the machine direction MD. While the fixed end 3662 is being pulled, the test sample 3130 must continue to lay substantially flat on the testing surface 3150. Pull 3670 on the fixed end 3662 until the force gage 3660 registers a specified force, then hold the fixed end 3662 at that displacement for at least ten seconds, so that the force gage 3660 continues to register the specified force.

While the force gage 3660 registers the specified force, use the linear scale to measure the necked down width 3773 of the test sample 3130. Measure the necked down width 3773 of the test sample 3130 at the narrowest width of the test sample 3130, which is at the midpoint of its overall length. Record the measurement for the necked down width 3773 as width in millimeters at the specified Newtons of force. Using the method described above, measure and record the necked down width 3773 for the following specified forces: 2.0 N, 4.0 N, 6.0 N, 8.0 N, 10.0 N, 12.0 N, 14.0 N, 16.0 N, 18.0 N, 20.0 N, 22.0 N, and 24.0 N.

Fourth, calculate the neckdown modulus. Using the force and width data measured and recorded as described above, for each pair of force/width data, determine the difference in force and the difference in width from the prior force and prior width. For example, determine the difference in force between no tension (0 Newtons) and 2.0 Newtons, resulting in a difference of 2.0 Newtons; then determine the difference in the width at no tension 3673 (0 Newtons) and the width at 2.0 Newtons of tension 3773; subtract the smaller value from the larger value to obtain positive results. Then, divide the difference in force values by the corresponding difference in width values, and multiple by 1000 to obtain a neckdown modulus value in Newtons per meter. Repeat this calculation for each pair of force/width data. Then take the average of these neckdown modulus values. The average is the neckdown modulus for the material of the test sample 3130. The testing should be repeated for two additional test samples. Take the average of these three samples. The average is the neckdown modulus for the material.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A bonded fibrous web comprising a bond pattern with bonds, wherein:
each of the bonds has a same overall length measured linearly from a first end of the bond to a second end of the bond and forming the bond's longest dimension;
each of the bonds has a same overall width measured linearly perpendicular to the overall length across the bond's widest width;
each of the bonds has a shape ratio, which is the ratio of the bond's overall width to the bond's overall length;
each shape ratio is less than or equal to 0.33;
the fibrous web includes a primary direction and a secondary direction that is orthogonal to the primary direction;
the bond pattern includes bonds, with at least some of the bonds laid out in primary rows that are parallel with the primary direction and at least some of the bonds laid out in secondary rows that are parallel with the secondary direction;
the bond pattern includes a shortest primary distance, measured linearly in the primary direction, between a bond in a secondary row and a bond in an adjacent secondary row;
the bond pattern has a shortest primary distance percentage, which is the shortest primary distance divided by the overall length of the bonds, times one hundred;
the shortest primary distance percentage is from −80% to 0%; and
the bond pattern has a bond area that is less than or equal to 20%.

2. The bonded fibrous web of claim 1, wherein each shape ratio is less than 0.20.

3. The bonded fibrous web of claim 1, wherein each shape ratio is less than 0.10.

4. The bonded fibrous web of claim 1, wherein each shape ratio is less than 0.05.

5. The bonded fibrous web of claim 1, wherein the shortest primary distance percentage is from −80% to −5%.

6. The bonded fibrous web of claim 1, wherein the shortest primary distance percentage is from −80% to −10%.

7. The bonded fibrous web of claim 1, wherein the shortest primary distance percentage is from −80% to −15%.

8. The bonded fibrous web of claim 1, wherein the shortest primary distance percentage is from −80% to −20%.

9. The bonded fibrous web of claim 1, wherein the bond pattern has a bond area that is less than or equal to 18%.

10. The bonded fibrous web of claim 1, wherein the bond pattern has a bond area that is less than or equal to 16%.

11. The bonded fibrous web of claim 1, wherein the bond pattern has a bond area that is less than or equal to 14%.

12. The bonded fibrous web of claim 1, wherein the bond pattern has a bond area that is less than or equal to 12%.

13. The bonded fibrous web of claim 1, wherein the bond pattern has a bond area that is less than or equal to 10%.

14. The bonded fibrous web of claim 1, wherein:
the bond pattern includes a shortest secondary distance, measured linearly in the secondary direction, between a bond in a primary row and a bond in an adjacent primary row;
the bond pattern has a shortest secondary distance percentage, which is the shortest secondary distance divided by the overall length of the bonds, times one hundred;
the shortest primary distance percentage is from −80% to 0%;

15. The bonded fibrous web of claim 14, wherein the shortest secondary distance percentage is from −80% to −5%.

16. The bonded fibrous web of claim 14, wherein the shortest secondary distance percentage is from −80% to −10%.

17. The bonded fibrous web of claim 14, wherein the shortest secondary distance percentage is from −80% to −15%.

18. The bonded fibrous web of claim 14, wherein the shortest secondary distance percentage is from −80% to −20%.

19. The bonded fibrous web of claim 1, wherein:
each of the bonds is oriented at a particular bond angle, which is the acute angle formed between the overall length of the bond and the secondary direction; and
the particular bond angle is from 25° to 60°.

20. The bonded fibrous web of claim 19, wherein the particular bond angle is from 30° to 50°.

21. The bonded fibrous web of claim 19, wherein the particular bond angle is from 30° to 40°.

22. The bonded fibrous web of claim 19, wherein the particular bond angle is from 33° to 37°.

23. The bonded fibrous web of claim 1, wherein the primary direction coincides with a machine direction of the web and the secondary direction coincides with a cross-direction of the web.

24. The bonded fibrous web of claim 1, wherein each of the bonds has an overall width that is less than or equal to 0.8 mm.

25. The bonded fibrous web of claim 1, wherein each of the bonds has an overall width that is less than or equal to 0.6 mm.

26. The bonded fibrous web of claim 1, wherein each of the bonds has an overall width that is less than or equal to 0.4 mm.

27. A disposable absorbent article comprising a bonded fibrous web having a bond pattern with bonds, wherein:
each of the bonds has a same overall length measured linearly from a first end of the bond to a second end of the bond and forming the bond's longest dimension;
each of the bonds has a same overall width measured linearly perpendicular to the overall length across the bond's widest width;
each of the bonds has a shape ratio, which is the ratio of the bond's overall width to the bond's overall length;
each shape ratio is less than or equal to 0.05;
the fibrous web includes a primary direction and a secondary direction that is orthogonal to the primary direction;
the bond pattern includes bonds, with at least some of the bonds laid out in primary rows that are parallel with the primary direction and at least some of the bonds laid out in secondary rows that are parallel with the secondary direction;
the bond pattern includes a shortest primary direction distance, measured linearly in the primary direction, between a bond in a secondary row and a bond in an adjacent secondary row;
the bond pattern has a shortest primary direction distance percentage, which is the shortest primary direction distance divided by the overall length of the bonds;
the shortest primary direction distance percentage is from −80% to −20%;
the bond pattern includes a shortest secondary direction distance, measured linearly in the secondary direction, between a bond in a primary row and a bond in an adjacent primary row;
the bond pattern has a shortest secondary direction distance percentage, which is the shortest secondary direction distance divided by the overall length of the bonds;
the shortest primary direction distance percentage is from −80% to −20%;
the bond pattern has a bond area that is less than or equal to 15%;
each of the bonds is oriented at a particular bond angle, which is the acute angle formed between the overall length of the bond and the secondary direction;
the particular angle is from 30° to 40°; and
each of the bonds has an overall width that is less than or equal to 0.5 mm.
